(19) United States
(12) Patent Application Publication
(10) Pub. No.: US 2026/0100797 A1
(43) Pub. Date: Apr. 9, 2026

(54) FREQUENCY DOMAIN RESOURCES FOR FULL-DUPLEX USER EQUIPMENT

(71) Applicant: QUALCOMM Incorporated, San Diego, CA (US)

(72) Inventors: Ahmed Attia ABOTABL, San Diego, CA (US); Muhammad Sayed Khairy ABDELGHAFFAR, San Jose, CA (US); Abdelrahman Mohamed Ahmed Mohamed IBRAHIM, San Diego, CA (US)

(21) Appl. No.: 18/910,819

(22) Filed: Oct. 9, 2024

(51) Int. Cl. H04L 5/00; H04L 5/14

(52) U.S. Cl. CPC H04L 5/0053; H04L 5/0092; H04L 5/14

(57) ABSTRACT

Various aspects of the present disclosure generally relate to wireless communication. In some aspects, a user equipment (UE) may receive, from a network node, a sub-band full-duplex (SBFD) frequency resource configuration indicating a first set of frequency resources for network node full-duplex communications, wherein the SBFD frequency resource configuration indicates a first guard band size of the first set of frequency resources. The UE may determine a second set of frequency resources for UE full-duplex communications in accordance with the SBFD frequency resource configuration, wherein the second set of frequency resources corresponds to a second guard band size. The UE may perform full-duplex communications via the second set of frequency resources. Numerous other aspects are described.

### FIELD OF THE DISCLOSURE

Aspects of the present disclosure generally relate to wireless communication and specifically relate to techniques, apparatuses, and methods associated with frequency domain resources for full-duplex user equipment.

### BACKGROUND

Wireless communication systems are widely deployed to provide various services, which may involve carrying or supporting voice, text, other messaging, video, data, and/or other traffic. Typical wireless communication systems may employ multiple-access radio access technologies (RATs) capable of supporting communication among multiple wireless communication devices including user devices or other devices by sharing the available system resources (for example, time domain resources, frequency domain resources, spatial domain resources, and/or device transmit power, among other examples). Such multiple-access RATs are supported by technological advancements that have been adopted in various telecommunication standards, which define common protocols that enable different wireless communication devices to communicate on a local, municipal, national, regional, or global level.

An example telecommunication standard is New Radio (NR). NR, which may also be referred to as 5G, is part of a continuous mobile broadband evolution promulgated by the Third Generation Partnership Project (3GPP). NR (and other RATs beyond NR) may be designed to better support enhanced mobile broadband (eMBB) access, Internet of things (IoT) networks or reduced capability device deployments, and ultra-reliable low latency communication (URLLC) applications. To support these verticals, NR systems may be designed to implement a modularized functional infrastructure, a disaggregated and service-based network architecture, network function virtualization, network slicing, multi-access edge computing, millimeter wave (mmWave) technologies including massive multiple-input multiple-output (MIMO), licensed and unlicensed spectrum access, non-terrestrial network (NTN) deployments, sidelink and other device-to-device direct communication technologies (for example, cellular vehicle-to-everything (CV2X) communication), multiple-subscriber implementations, high-precision positioning, and/or radio frequency (RF) sensing, among other examples. As the demand for connectivity continues to increase, further improvements in NR may be implemented, and other RATs, such as 6G and beyond, may be introduced to enable new applications and facilitate new use cases.

### SUMMARY

Some aspects described herein relate to an apparatus for wireless communication at a user equipment (UE). The apparatus may include one or more memories and one or more processors coupled to the one or more memories. The one or more processors may be configured to receive, from a network node, a sub-band full-duplex (SBFD) frequency resource configuration indicating a first set of frequency resources for network node full-duplex communications, wherein the SBFD frequency resource configuration indicates a first guard band size of the first set of frequency resources. The one or more processors may be configured to determine a second set of frequency resources for UE full-duplex communications in accordance with the SBFD frequency resource configuration, wherein the second set of frequency resources corresponds to a second guard band size. The one or more processors may be configured to perform full-duplex communications via the second set of frequency resources.

Some aspects described herein relate to an apparatus for wireless communication at a network node. The apparatus may include one or more memories and one or more processors coupled to the one or more memories. The one or more processors may be configured to transmit, to a UE, a first SBFD frequency resource configuration indicating a first set of frequency resources that are for network node full-duplex communications, wherein the SBFD frequency resource configuration indicates a first guard band size of the first set of frequency resources. The one or more processors may be configured to transmit, to the UE, an indication associated with a second set of frequency resources that are for UE full-duplex communications, wherein the second set of frequency resources corresponds to a second guard band size. The one or more processors may be configured to perform full-duplex communications via the first set of frequency resources.

Some aspects described herein relate to a method of wireless communication performed by a UE. The method may include receiving, from a network node, an SBFD frequency resource configuration indicating a first set of frequency resources for network node full-duplex communications, wherein the SBFD frequency resource configuration indicates a first guard band size of the first set of frequency resources. The method may include determining a second set of frequency resources for UE full-duplex communications in accordance with the SBFD frequency resource configuration, wherein the second set of frequency resources corresponds to a second guard band size. The method may include performing full-duplex communications via the second set of frequency resources.

Some aspects described herein relate to a method of wireless communication performed by a network node. The method may include transmitting, to a UE, a first SBFD frequency resource configuration indicating a first set of frequency resources that are for network node full-duplex communications, wherein the SBFD frequency resource configuration indicates a first guard band size of the first set of frequency resources. The method may include transmitting, to the UE, an indication associated with a second set of frequency resources that are for UE full-duplex communications, wherein the second set of frequency resources corresponds to a second guard band size. The method may include performing full-duplex communications via the first set of frequency resources.

Some aspects described herein relate to a non-transitory computer-readable medium that stores a set of instructions for wireless communication by a UE. The set of instructions, when executed by one or more processors of the UE, may cause the UE to receive, from a network node, an SBFD frequency resource configuration indicating a first set of frequency resources for network node full-duplex communications, wherein the SBFD frequency resource configuration indicates a first guard band size of the first set of frequency resources. The set of instructions, when executed by one or more processors of the UE, may cause the UE to determine a second set of frequency resources for UE full-duplex communications in accordance with the SBFD frequency resource configuration, wherein the second set of frequency resources corresponds to a second guard band size. The set of instructions, when executed by one or more processors of the UE, may cause the UE to perform full-duplex communications via the second set of frequency resources.

Some aspects described herein relate to a non-transitory computer-readable medium that stores a set of instructions for wireless communication by a network node. The set of instructions, when executed by one or more processors of the network node, may cause the network node to transmit, to a UE, a first SBFD frequency resource configuration indicating a first set of frequency resources that are for network node full-duplex communications, wherein the SBFD frequency resource configuration indicates a first guard band size of the first set of frequency resources. The set of instructions, when executed by one or more processors of the network node, may cause the network node to transmit, to the UE, an indication associated with a second set of frequency resources that are for UE full-duplex communications, wherein the second set of frequency resources corresponds to a second guard band size. The set of instructions, when executed by one or more processors of the network node, may cause the network node to perform full-duplex communications via the first set of frequency resources.

Some aspects described herein relate to an apparatus for wireless communication. The apparatus may include means for receiving, from a network node, an SBFD frequency resource configuration indicating a first set of frequency resources for network node full-duplex communications, wherein the SBFD frequency resource configuration indicates a first guard band size of the first set of frequency resources. The apparatus may include means for determining a second set of frequency resources for UE full-duplex communications in accordance with the SBFD frequency resource configuration, wherein the second set of frequency resources corresponds to a second guard band size. The apparatus may include means for performing full-duplex communications via the second set of frequency resources.

Some aspects described herein relate to an apparatus for wireless communication. The apparatus may include means for transmitting, to a UE, a first SBFD frequency resource configuration indicating a first set of frequency resources that are for network node full-duplex communications, wherein the SBFD frequency resource configuration indicates a first guard band size of the first set of frequency resources. The apparatus may include means for transmitting, to the UE, an indication associated with a second set of frequency resources that are for UE full-duplex communications, wherein the second set of frequency resources corresponds to a second guard band size. The apparatus may include means for performing full-duplex communications via the first set of frequency resources.

Aspects of the present disclosure may generally be implemented by or as a method, apparatus, system, computer program product, non-transitory computer-readable medium, user equipment, base station, network node, network entity, wireless communication device, and/or processing system as substantially described with reference to, and as illustrated by, this specification and accompanying drawings.

The foregoing paragraphs of this section have broadly summarized some aspects of the present disclosure. These and additional aspects and associated advantages will be described hereinafter. The disclosed aspects may be used as a basis for modifying or designing other aspects for carrying out the same or similar purposes of the present disclosure. Such equivalent aspects do not depart from the scope of the appended claims. Characteristics of the aspects disclosed herein, both their organization and method of operation, together with associated advantages, will be better understood from the following description when considered in connection with the accompanying drawings.

### BRIEF DESCRIPTION OF THE DRAWINGS

The appended drawings illustrate some aspects of the present disclosure but are not limiting of the scope of the present disclosure because the description may enable other aspects. Each of the drawings is provided for purposes of illustration and description, and not as a definition of the limits of the claims. The same or similar reference numbers in different drawings may identify the same or similar elements.

FIG. 1 is a diagram illustrating an example of a wireless communication network, in accordance with the present disclosure.

FIG. 2 is a diagram illustrating an example disaggregated network node architecture, in accordance with the present disclosure.

FIG. 3 is a diagram illustrating examples of full-duplex communication in a wireless network, in accordance with the present disclosure.

FIG. 4 is a diagram illustrating an example of a full-duplex zone, a non-full-duplex zone, and self-interference associated with full-duplex communications, in accordance with the present disclosure.

FIG. 5 is a diagram illustrating examples of full-duplex communications, in accordance with the present disclosure.

FIG. 6 is a diagram of an example associated with user equipment (UE) sub-band full-duplex (SBFD) resource determination, in accordance with the present disclosure.

FIG. 7 is a diagram illustrating examples associated with frequency resources for SBFD communications, in accordance with the present disclosure.

FIG. 8 is a diagram illustrating examples associated with determining frequency resources for UE SBFD communications, in accordance with the present disclosure.

FIG. 9 is a diagram illustrating examples associated with frequency resources for UE SBFD communications, in accordance with the present disclosure.

FIG. 10 is a diagram illustrating an example process performed, for example, at a UE or an apparatus of a UE, in accordance with the present disclosure.

FIG. 11 is a diagram illustrating an example process performed, for example, at a network node or an apparatus of a network node, in accordance with the present disclosure.

FIG. 12 is a diagram of an example apparatus for wireless communication, in accordance with the present disclosure.

FIG. 13 is a diagram of an example apparatus for wireless communication, in accordance with the present disclosure.

### DETAILED DESCRIPTION

Various aspects of the present disclosure are described hereinafter with reference to the accompanying drawings. However, aspects of the present disclosure may be embodied in many different forms. The present disclosure is not to be construed as limited to any specific aspect illustrated by or described with reference to an accompanying drawing or otherwise presented in this disclosure. Rather, these aspects are provided so that this disclosure will be thorough and complete, and will fully convey the scope of the disclosure to those skilled in the art. One skilled in the art may appreciate that the scope of the disclosure is intended to cover any aspect of the disclosure disclosed herein, whether implemented independently of or in combination with any other aspect of the disclosure. For example, an apparatus may be implemented or a method may be practiced using various combinations or quantities of the aspects set forth herein. In addition, the scope of the disclosure is intended to cover an apparatus having, or a method that is practiced using, other structures and/or functionalities in addition to or other than the structures and/or functionalities with which various aspects of the disclosure set forth herein may be practiced. Any aspect of the disclosure disclosed herein may be embodied by one or more elements of a claim.

Several aspects of telecommunication systems will now be presented with reference to various methods, operations, apparatuses, and techniques. These methods, operations, apparatuses, and techniques will be described in the following detailed description and illustrated in the accompanying drawings by various blocks, modules, components, circuits, steps, processes, or algorithms (collectively referred to as “elements”). These elements may be implemented using hardware, software, or a combination of hardware and software. Whether such elements are implemented as hardware or software depends upon the particular application and design constraints imposed on the overall system.

A network node may use sub-band full-duplex (SBFD) operation to communicate on a downlink sub-band and an uplink sub-band concurrently. For example, the network node may transmit information to a first user equipment (UE) on the first sub-band and receive information from a second UE on the second sub-band. This may be referred to as a network node SBFD mode. The network node may divide a carrier into sub-bands for SBFD operation in accordance with an SBFD pattern. For example, the network node may divide a carrier (e.g., a component carrier (CC)) into a first sub-band for downlink communication and a second sub-band for uplink communication. Similarly, a UE that has a full-duplex capability may also operate in an SBFD mode, which may be referred to as a UE SBFD mode. For example, a single UE may receive information on a first sub-band and transmit information on a second sub-band, concurrently, with the sub-bands being based on an SBFD configuration.

An “SBFD time resource” may refer to a slot in which an SBFD configuration is used. An SBFD configuration may include a slot configuration in which full-duplex communication is supported (e.g., for both uplink and downlink communications), with one or more frequencies used for an uplink portion of the slot being separated from one or more frequencies used for a downlink portion of the slot by a guard band.

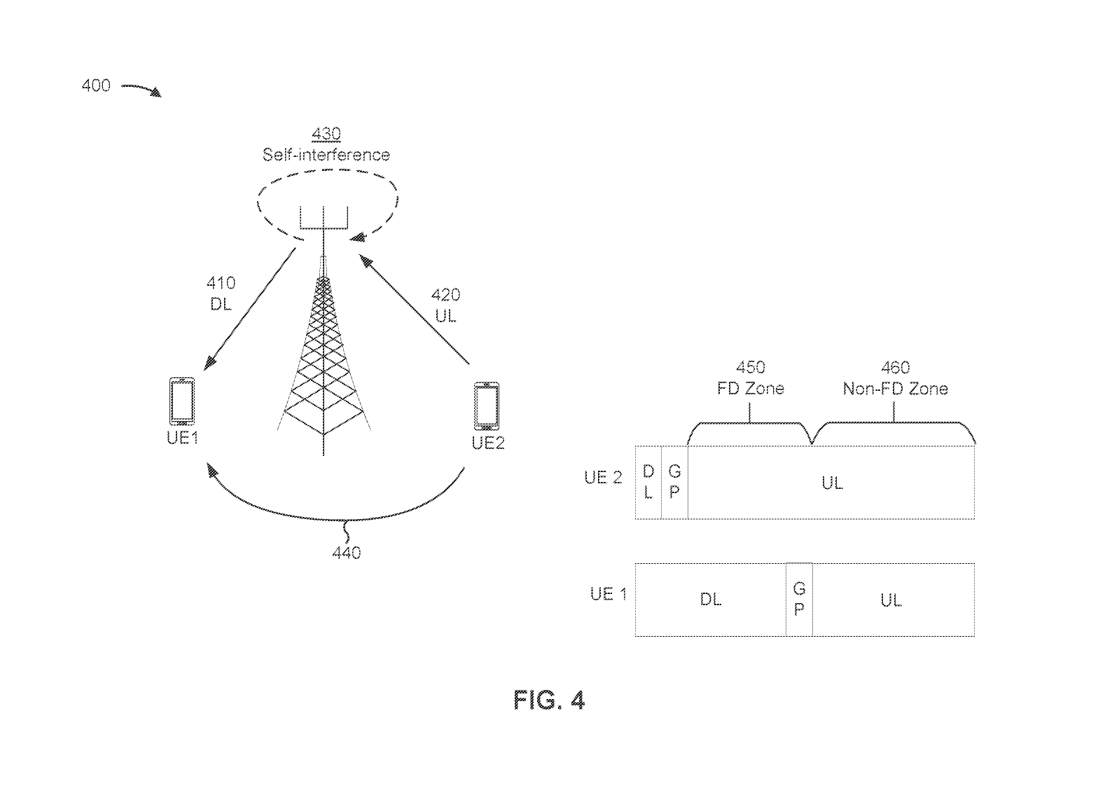

In some examples, a format of the SBFD time resource may include a single uplink portion and a single downlink portion separated by a guard band. In some examples, a format of the SBFD time resource may include multiple downlink portions and a single uplink portion that is separated from the multiple downlink portions by respective guard bands (e.g., as shown in FIG. 4). In some examples, a format of the SBFD time resource may include multiple uplink portions and a single downlink portion that is separated from the multiple uplink portions by respective guard bands. In some examples, a format of the SBFD time resource may include multiple uplink portions and multiple downlink portions, where each uplink portion is separated from a downlink portion by a guard band and each SBFD time resource may include one or more guard bands.

The one or more guard bands may reduce a likelihood of self-interference between downlink communications and uplink communications. For example, a network node may experience interference when simultaneous uplink and downlink communications occur via frequency resources that are contiguous or relatively close in frequency to each other. By separating frequency resources of SBFD time resource with a guard band, the likelihood and/or effects of self-interference are reduced. For example, a downlink frequency resource in the SBFD slot may be separated (e.g., in frequency) from an uplink frequency resource in the SBFD slot by a guard band, which may function to reduce self-interference and improve latency and uplink coverage. The gap may be a frequency offset or a frequency gap (e.g., guard band) between frequency resources in the same SBFD slot.

In some examples, SBFD communications may be supported by different antenna panels. For example, a first antenna panel may communicate uplink and/or downlink communications while a second antenna panel may communicate downlink and/or uplink communications. Because the network node may be relatively larger than a UE, a physical separation between antenna panels of the network node may be larger than a physical separation of antenna panels at a UE. Thus, because uplink and/or downlink antenna panels may have a relatively large physical separation, the network node may use a relatively narrow guard band size to perform SBFD communications to achieve a baseline quality of communications and/or effectively mitigate self-interference. However, for an SBFD-enabled UE, the physical separation between uplink and downlink antenna panels may be relatively small and thus the UE may need to mitigate more self-interference to achieve a baseline quality of communications and/or effectively mitigate self-interference.

An SBFD-capable UE may benefit from implementing a larger guard band to mitigate self-interference. Various aspects relate generally to frequency domain resource determination for full-duplex capable UEs. Some aspects more specifically relate to determining a frequency domain resource configuration, including frequency resources and guard bands, for UE SBFD communications. Some aspects more specifically relate to determining the frequency domain resource configuration for UE SBFD communications based on a frequency domain resource configuration for network node SBFD communications and/or the explicit indication of frequency resources and/or guard bands for UE SBFD communications. In some aspects, a UE may receive, and a network node may transmit, an SBFD frequency resource configuration indicating a first set of frequency resources for network node full-duplex communications. In some aspects, the SBFD frequency resource configuration indicates a first guard band size of the first set of frequency resources. In some aspects, the UE may determine a second set of frequency resources for UE full-duplex communications in accordance with the SBFD frequency resource configuration. In some aspects, the second set of frequency resources may correspond to a second guard band size. In some aspects, the second guard band size may be larger than the first guard band size. In some aspects, the UE and/or the network node may perform full-duplex communications via the second set of frequency resources or the first set of frequency resources respectively.

In some aspects, the UE may determine the second set of frequency resources by deriving the second set of frequency resources from the first set of frequency resources. For example, the UE may increase the guard band value by an extension value to obtain the second guard band size. In some aspects, the UE may decrease the frequency range of one or more frequency resources of the first set of frequency resources to determine the second set of frequency resources. In some aspects, the extension value may be applied to one or more guard bands such that a frequency range of each downlink frequency resource is decreased and/or a frequency range of each uplink frequency resource is decreased.

Particular aspects of the subject matter described in this disclosure can be implemented to realize one or more of the following potential advantages. In some examples, the described techniques can be used to increase throughput and channel quality. For example, by determining the frequency domain resource configuration for UE SBFD communications based on a frequency domain resource configuration for network node SBFD communications, the UE may reduce signaling and conserve resources by determining the UE SBFD frequency resources without additional signaling and/or resource consumption. By determining the frequency domain resource configuration for UE SBFD communications based on the explicit indication of frequency resources and/or guard bands for UE SBFD communications, the UE may conserve processing power and reduce battery consumption that would be otherwise used to derive the UE SBFD frequency resources. By communicating the SBFD frequency resource configuration indicating the first set of frequency resources for network node full-duplex communications, the UE may determine when to perform full-duplex communications and/or half-duplex communications more quickly than determining when to perform full-duplex communications and/or half-duplex communications without an explicit indication and may thereby conserve resources used for sensing, requesting resources, and may increase the reliability of communications by communicating via the indicated resources. By the second guard band being larger than the first guard band, self-interference at the UE may be reduced for UE SBFD communications. By the UE decreasing the frequency range of one or more frequency resources of the first set of frequency resources to determine the second set of frequency resources, the UE may reuse resources already dedicated to network node SBFD communications which may support spectral efficiency. By the UE may decreasing the frequency range of each downlink frequency resource of the first set of frequency resources and/or decreasing the frequency range of each downlink frequency resource of the first set of frequency resources to determine the second set of frequency resources and increase a guard band size, the UE and/or the network node may adaptively configure resources to efficiently accommodate uplink and/or downlink traffic volume.

As described above, wireless communication systems may be deployed to provide various services, which may involve carrying or supporting voice, text, other messaging, video, data, and/or other traffic. Some wireless communications systems may employ multiple-access radio access technologies (RATs). The multiple-access RATs may be capable of supporting communication with multiple wireless communication devices by sharing the available system resources (for example, time domain resources, frequency domain resources, spatial domain resources, and/or device transmit power, among other examples). Examples of such multiple-access RATs include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, and time division synchronous code division multiple access (TD-SCDMA) systems.

Multiple-access RATs are supported by technological advancements that have been adopted in various telecommunication standards, which define common protocols that enable wireless communication devices to communicate on a local, municipal, enterprise, national, regional, or global level. For example, 5G New Radio (NR) is part of a continuous mobile broadband evolution promulgated by the Third Generation Partnership Project (3GPP). 5G NR may support enhanced mobile broadband (eMBB) access, Internet of Things (IoT) networks or reduced capability (RedCap) device deployments, ultra-reliable low-latency communication (URLLC) applications, and/or massive machine-type communication (mMTC), among other examples.

To support these and other target verticals, a wireless communication system may be designed to implement a modularized functional infrastructure, a disaggregated and service-based network architecture, network function virtualization, network slicing, multi-access edge computing, millimeter wave (mmWave) technologies including massive multiple-input multiple-output (MIMO), beamforming, IoT device or RedCap device connectivity and management, industrial connectivity, licensed and unlicensed spectrum access, sidelink and other device-to-device direct communication (for example, cellular vehicle-to-everything (CV2X) communication), frequency spectrum expansion, overlapping spectrum use, small cell deployments, non-terrestrial network (NTN) deployments, device aggregation, advanced duplex communication (for example, SBFD), multiple-subscriber implementations, high-precision positioning, radio frequency (RF) sensing, network energy savings (NES), low-power signaling and radios, and/or artificial intelligence or machine learning (AI/ML), among other examples.

The foregoing and other technological improvements may support use cases, such as wireless fronthauls, wireless midhauls, wireless backhauls, wireless data centers, extended reality (XR) and metaverse applications, meta services for supporting vehicle connectivity, holographic and mixed reality communication, autonomous and collaborative robots, vehicle platooning and cooperative maneuvering, sensing networks, gesture monitoring, human-brain interfacing, digital twin applications, asset management, and universal coverage applications using non-terrestrial and/or aerial platforms, among other examples.

As the demand for connectivity continues to increase, further improvements in NR may be implemented, and other RATs, such as 6G and beyond, may be introduced to enable new applications and facilitate new use cases. The methods, operations, apparatuses, and techniques described herein may enable one or more of the foregoing technologies or new technologies and/or support one or more of the foregoing use cases or new use cases.

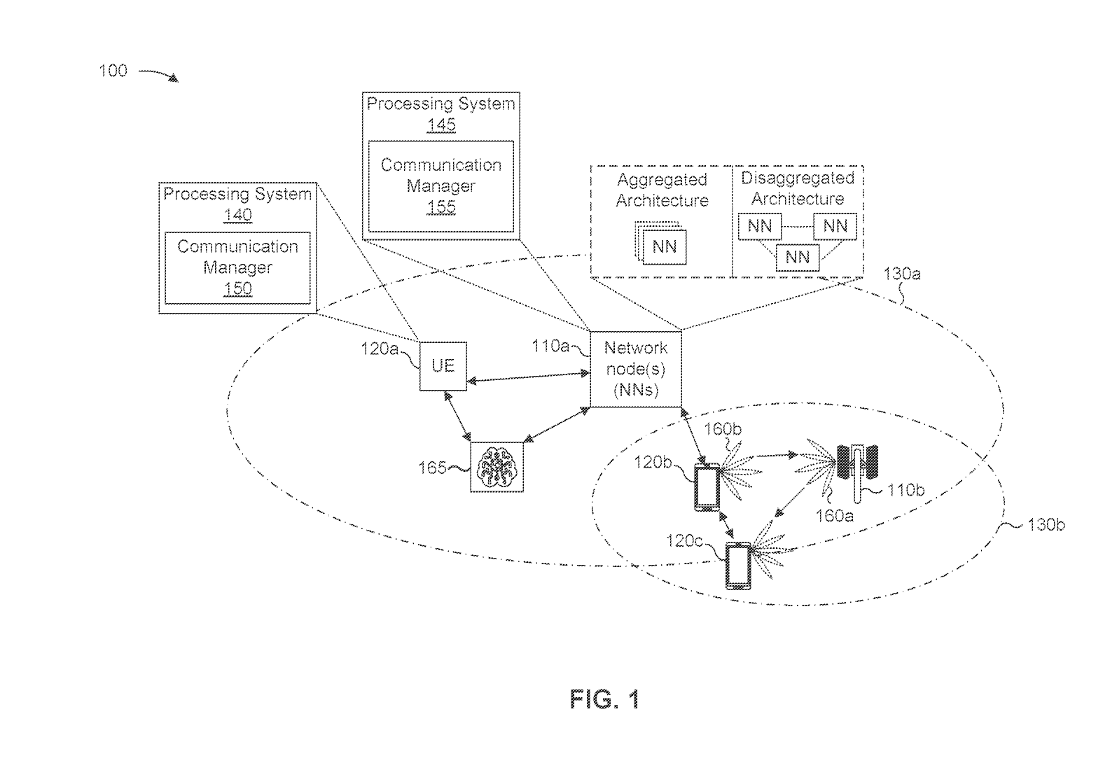

FIG. 1 is a diagram illustrating an example of a wireless communication network 100, in accordance with the present disclosure. The wireless communication network 100 may be or may include elements of a 5G (or NR) network or a 6G network, among other examples. The wireless communication network 100 may include multiple network nodes 110. For example, in FIG. 1, the wireless communication network 100 includes a network node (NN) 110a and a network node 110b. The network nodes 110 may support communications with multiple UEs 120. For example, in FIG. 1, the network nodes 110 support communication with a UE 120a, a UE 120b, and a UE 120c. In some examples, a UE 120 may also communicate with other UEs 120 and a network node 110 may communicate with a core network and with other network nodes 110.

The network nodes 110 and the UEs 120 of the wireless communication network 100 may communicate using the electromagnetic spectrum, which may be subdivided by frequency or wavelength into various classes, bands, carriers, and/or channels. For example, devices of the wireless communication network 100 may communicate using one or more operating bands. In some aspects, multiple wireless communication networks 100 may be deployed in a given geographic area. Each wireless communication network 100 may support a particular RAT (which may also be referred to as an air interface) and may operate on one or more carrier frequencies in one or more frequency bands or ranges. In some examples, when multiple RATs are deployed in a given geographic area, each RAT in the geographic area may operate on different frequencies to avoid interference with other RATs. Additionally or alternatively, in some examples, the wireless communication network 100 may implement dynamic spectrum sharing (DSS), in which multiple RATs are implemented with dynamic bandwidth allocation (for example, based on user demand) in a single frequency band. In some examples, the wireless communication network 100 may support communication over unlicensed spectrum, where access to an unlicensed channel is subject to a channel access mechanism. For example, in a shared or unlicensed frequency band, a transmitting device may perform a channel access procedure, such as a listen-before-talk (LBT) procedure, to contend against other devices for channel access before transmitting on a shared or unlicensed channel.

Various operating bands have been defined as frequency range designations FR1 (410 MHz through 7.125 GHz), FR2 (24.25 GHz through 52.6 GHz), FR3 (7.125 GHz through 24.25 GHz), FR4a or FR4-1 (52.6 GHz through 71 GHz), FR4 (52.6 GHz through 114.25 GHz), and FR5 (114.25 GHz through 300 GHz). Although a portion of FR1 is greater than 6 GHz, FR1 is often referred to (interchangeably) as a “sub-6 GHz” band in some documents and articles. Similarly, FR2 is often referred to (interchangeably) as a “millimeter wave” band in some documents and articles, despite being different than the extremely high frequency (EHF) band (30 GHz through 300 GHz), which is identified by the International Telecommunications Union (ITU) as a “millimeter wave” band. The frequencies between FR1 and FR2 are often referred to as mid-band frequencies, which include FR3. Frequency bands falling within FR3 may inherit FR1 characteristics or FR2 characteristics, and thus may effectively extend features of FR1 or FR2 into the mid-band frequencies. Thus, “sub-6 GHz,” if used herein, may broadly refer to frequencies that are less than 6 GHz, that are within FR1, and/or that are included in mid-band frequencies. Similarly, the term “millimeter wave,” if used herein, may broadly refer to mid-band frequencies or to frequencies that are within FR2, FR4, FR4-a or FR4-1, FR5, and/or the EHF band. Higher frequency bands may extend 5G NR operation, 6G operation, and/or other RATs beyond 52.6 GHz.

A network node 110 and/or a UE 120 may include one or more devices, components, or systems that enable communication with other devices, components, or systems of the wireless communication network 100. For example, a UE 120 and a network node 110 may each include one or more chips, system-on-chips (SoCs), chipsets, packages, or devices that individually or collectively constitute or comprise a processing system, such as a processing system 140 of the UE 120 or a processing system 145 of the network node 110. A processing system (for example, the processing system 140 and/or the processing system 145) includes processor (or “processing”) circuitry in the form of one or multiple processors, microprocessors, processing units (such as central processing units (CPUs), graphics processing units (GPUs), neural processing units (NPUs) (also referred to as neural network processors or deep learning processors (DLPs)), and/or digital signal processors (DSPs)), processing blocks, application-specific integrated circuits (ASICs), programmable logic devices (PLDs), or other discrete gate or transistor logic or circuitry (any one or more of which may be generally referred to herein individually as a “processor” or collectively as “the processor” or “the processor circuitry”). Such processors may be individually or collectively configurable or configured to perform various functions or operations described herein. A group of processors collectively configurable or configured to perform a set of functions may include a first processor configurable or configured to perform a first function of the set and a second processor configurable or configured to perform a second function of the set. In some other examples, each of a group of processors may be configurable or configured to perform a same set of functions.

The processing system 140 and the processing system 145 may each include memory circuitry in the form of one or multiple memory devices, memory blocks, memory elements, or other discrete gate or transistor logic or circuitry, each of which may include or implement tangible storage media such as random-access memory (RAM) or read-only memory (ROM), or combinations thereof (any one or more of which may be generally referred to herein individually as a “memory” or collectively as “the memory” or “the memory circuitry”). One or more of the memories may be coupled (for example, operatively coupled, communicatively coupled, electronically coupled, or electrically coupled) with one or more of the processors and may individually or collectively store processor-executable code or instructions (such as software) that, when executed by one or more of the processors, may configure one or more of the processors to perform various functions or operations described herein. Additionally or alternatively, in some examples, one or more of the processors may be configured to perform various functions or operations described herein without requiring configuration by software. “Software” shall be construed broadly to mean instructions, instruction sets, code, code segments, program code, programs, subprograms, software modules, applications, software applications, software packages, routines, subroutines, objects, executables, threads of execution, procedures, or functions, among other examples, whether referred to as software, firmware, middleware, microcode, hardware description language, or otherwise.

The processing system 140 and the processing system 145 may each include or be coupled with one or more modems (such as a cellular (for example, a 5G or 6G compliant) modem). In some examples, one or more processors of the processing system 140 and/or the processing system 145 include or implement one or more of the modems. The processing system 140 and the processing system 145 may also include or be coupled with multiple radios (collectively “the radio”), multiple RF chains, or multiple transceivers, each of which may in turn be coupled with one or more of multiple antennas. In some examples, one or more processors of the processing system 140 and/or the processing system 145 include or implement one or more of the radios, RF chains, or transceivers. An RF chain may include one or more filters, mixers, oscillators, amplifiers, analog-to-digital converters (ADCs), and/or other devices that convert between an analog signal (such as for transmission or reception via an air interface) and a digital signal (such as for processing by the processing system 140 of the UE 120 or by the processing system 145 of the network node 110).

A network node 110 and a UE 120 may each include one or multiple antennas or antenna arrays. Typical network nodes 110 and UEs 120 may include multiple antennas, which may be organized or structured into one or more antenna panels, one or more antenna groups, one or more sets of antenna elements, or one or more antenna arrays, among other examples. As used herein, the term “antenna” can refer to one or more antennas, one or more antenna panels, one or more antenna groups, one or more sets of antenna elements, or one or more antenna arrays. The term “antenna panel” can refer to a group of antennas (such as antenna elements) arranged in an array or panel, which may facilitate beamforming by manipulating parameters associated with the group of antennas. The term “antenna module” may refer to circuitry including one or more antennas as well as one or more other components (such as filters, amplifiers, or processors) associated with integrating the antenna module into a wireless communication device such as the network node 110 and the UE 120.

A network node 110 may be, may include, or may also be referred to as an NR network node, a 5G network node, a 6G network node, a Node B, a gNB, an access point (AP), a transmission reception point (TRP), a network entity, a network element, a network equipment, and/or another type of device, component, or system included in a radio access network (RAN). In various deployments, a network node 110 may be implemented as a single physical node (for example, a single physical structure) or may be implemented as two or more physical nodes (for example, two or more distinct physical structures). For example, a network node 110 may be a device or system that implements a part of a radio protocol stack, a device or system that implements a full radio protocol stack (such as a full gNB protocol stack), or a collection of devices or systems that collectively implement the full radio protocol stack. For example, and as shown, a network node 110 may be an aggregated network node having an aggregated architecture, meaning that the network node 110 may implement a full radio protocol stack that is physically and logically integrated within a single physical structure in the wireless communication network 100. For example, an aggregated network node 110 may consist of a single standalone base station or a single TRP that operates with a full radio protocol stack to enable or facilitate communication between a UE 120 and a core network of the wireless communication network 100.

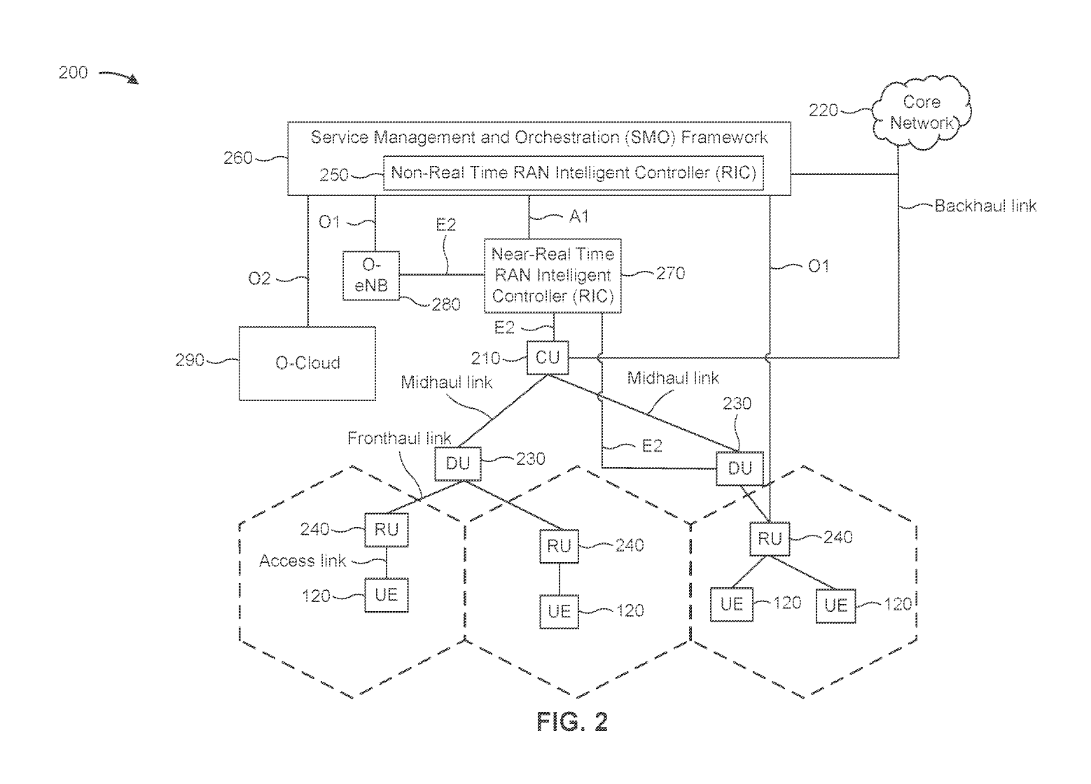

Alternatively, and as also shown, a network node 110 may be a disaggregated network node (sometimes referred to as a disaggregated base station), having a disaggregated architecture, meaning that the network node 110 may operate with a radio protocol stack that is physically distributed and/or logically distributed among two or more nodes in the same geographic location or in different geographic locations. An example disaggregated network node architecture is described in more detail below with reference to FIG. 2. In some deployments, disaggregated network nodes 110 may be used in an integrated access and backhaul (IAB) network, in an open radio access network (O-RAN) (such as a network configuration in compliance with the O-RAN Alliance), or in a virtualized radio access network (vRAN), also known as a cloud radio access network (C-RAN), to facilitate scaling by separating network functionality into multiple units or modules that can be individually deployed.

The network nodes 110 of the wireless communication network 100 may include one or more central units (CUs), one or more distributed units (DUs), and one or more radio units (RUs). A CU may host one or more higher layers, such as a radio resource control (RRC) layer, a packet data convergence protocol (PDCP) layer, and a service data adaptation protocol (SDAP) layer, among other examples. A DU may host one or more of a radio link control (RLC) layer, a medium access control (MAC) layer, and/or one or more higher physical (PHY) layers depending, at least in part, on a functional split, such as a functional split defined by the 3GPP. In some examples, a DU also may host a lower PHY layer that is configured to perform functions, such as a fast Fourier transform (FFT), an inverse FFT (IFFT), beamforming, and/or physical random access channel (PRACH) extraction and filtering, among other examples. An RU may perform RF processing functions or lower PHY layer functions, such as an FFT, an IFFT, beamforming, or PRACH extraction and filtering, among other examples, according to a functional split, such as a lower layer split (LLS). In such an architecture, each RU can be operated to handle over the air (OTA) communication with one or more UEs 120. In some examples, a single network node 110 may include a combination of one or more CUs, one or more DUs, and/or one or more RUs. In some examples, a CU, a DU, and/or an RU may be implemented as a virtual unit, such as a virtual central unit (VCU), a virtual distributed unit (VDU), or a virtual radio unit (VRU), among other examples, which may be implemented as a virtual network function, such as in a cloud deployment.

Some network nodes 110 (for example, a base station, an RU, or a TRP) may provide communication coverage for a particular geographic area. The term “cell” can refer to a coverage area of a network node 110 or to a network node 110 itself, depending on the context in which the term is used. A network node 110 may support one or more cells (for example, each cell may support communication within an angular (for example, 60 degree) range around the network node). In some examples, a network node 110 may provide communication coverage for a macro cell, a pico cell, a femto cell, or another type of cell. A macro cell may cover a relatively large geographic area (for example, several kilometers in radius) and may allow unrestricted access by UEs 120 with associated service subscriptions. A pico cell may cover a relatively small geographic area and may also allow unrestricted access by UEs 120 with associated service subscriptions. A femto cell may cover a relatively small geographic area (for example, a home) and may allow restricted access by UEs 120 having association with the femto cell (for example, UEs 120 in a closed subscriber group (CSG)). In some examples, a cell may not necessarily be stationary. For example, the geographic area of the cell may move according to the location of an associated mobile network node 110 (for example, a train, a satellite, an unmanned aerial vehicle, or an NTN network node).

The wireless communication network 100 may be a heterogeneous network that includes network nodes 110 of different types, such as macro network nodes, pico network nodes, femto network nodes, relay network nodes, aggregated network nodes, and/or disaggregated network nodes, among other examples. Various different types of network nodes 110 may generally transmit at different power levels, serve different coverage areas (for example, a cell 130a and a cell 130b), and/or have different impacts on interference in the wireless communication network 100 than other types of network nodes 110.

The UEs 120 may be physically dispersed throughout the coverage area of the wireless communication network 100, and each UE 120 may be stationary or mobile. A UE 120 may be, may include, or may also be referred to as an access terminal, a mobile station, or a subscriber unit. A UE 120 may be, include, or be coupled with a cellular phone (for example, a smart phone), a personal digital assistant (PDA), a wireless modem, a wireless communication device, a handheld device, a laptop computer, a cordless phone, a wireless local loop (WLL) station, a tablet, a camera, a netbook, a smartbook, an ultrabook, a medical device, a biometric device, a wearable device (for example, a smart watch, smart clothing, smart glasses, a smart wristband, or smart jewelry), a gaming device, an entertainment device (for example, a music device, a video device, or a satellite radio), an XR device, a vehicular component or sensor, a smart meter or sensor, industrial manufacturing equipment, a Global Navigation Satellite System (GNSS) device (such as a Global Positioning System device or another type of positioning device), a UE function of a network node, and/or any other suitable device or function that may communicate via a wireless medium.

Some UEs 120 may be classified according to different categories in association with different complexities and/or different capabilities. UEs 120 in a first category may facilitate massive IoT in the wireless communication network 100, and may offer low complexity and/or cost relative to UEs 120 in a second category. UEs 120 in a second category may include mission-critical IoT devices, legacy UEs, baseline UEs, high-tier UEs, advanced UEs, full-capability UEs, and/or premium UEs that are capable of URLLC, eMBB, and/or precise positioning in the wireless communication network 100, among other examples. A third category of UEs 120 may have mid-tier complexity and/or capability (for example, a capability between that of the UEs 120 of the first category and that of the UEs 120 of the second capability). A UE 120 of the third category may be referred to as a reduced capability UE (“RedCap UE”), a mid-tier UE, an NR-Light UE, and/or an NR-Lite UE, among other examples. RedCap UEs may bridge a gap between the capability and complexity of NB-IoT devices and/or eMTC UEs, and mission-critical IoT devices and/or premium UEs. RedCap UEs may include, for example, wearable devices, IoT devices, industrial sensors, or cameras that are associated with a limited bandwidth, power capacity, and/or transmission range, among other examples. RedCap UEs may support healthcare environments, building automation, electrical distribution, process automation, transport and logistics, or smart city deployments, among other examples.

In some examples, a network node 110 may be, may include, or may operate as an RU, a TRP, or a base station that communicates with one or more UEs 120 via a radio access link (which may be referred to as a “Uu” link). The radio access link may include a downlink and an uplink. “Downlink” (or “DL”) refers to a communication direction from a network node 110 to a UE 120, and “uplink” (or “UL”) refers to a communication direction from a UE 120 to a network node 110. Downlink and uplink resources may include time domain resources (for example, frames, subframes, slots, and symbols), frequency domain resources (for example, frequency bands, component carriers (CCs), subcarriers, resource blocks, and resource elements), and spatial domain resources (for example, particular transmit directions or beams).

Frequency domain resources may be subdivided into bandwidth parts (BWPs). A BWP may be a block of frequency domain resources (for example, a continuous set of resource blocks (RBs) within a full component carrier bandwidth) that may be configured at a UE-specific level. A UE 120 may be configured with both an uplink BWP and a downlink BWP (which may be the same or different). Each BWP may be associated with its own numerology (indicating a sub-carrier spacing (SCS) and cyclic prefix (CP)). A BWP may be dynamically configured or activated (for example, by a network node 110 transmitting a downlink control information (DCI) configuration to the one or more UEs 120) and/or reconfigured (for example, in real-time or near-real-time) according to changing network conditions in the wireless communication network 100 and/or specific requirements of one or more UEs 120. An active BWP defines the operating bandwidth of the UE 120 within the operating bandwidth of the serving cell. The use of BWPs enables more efficient use of the available frequency domain resources in the wireless communication network 100 because fewer frequency domain resources may be allocated to a BWP for a UE 120 (which may reduce the quantity of frequency domain resources that a UE 120 is required to monitor and reduce UE power consumption by enabling the UE to monitor fewer frequency domain resources), leaving more frequency domain resources to be spread across multiple UEs 120. Thus, BWPs may also assist in the implementation of lower-capability (for example, RedCap) UEs 120 by facilitating the configuration of smaller bandwidths for communication by such UEs 120 and/or by facilitating reduced UE power consumption.

As used herein, a downlink signal may be or include a reference signal, control information, or data. For example, downlink reference signals include a primary synchronization signal (PSS), a secondary SS (SSS), an SS block (SSB) (for example, that includes a PSS, an SSS, and a physical broadcast channel (PBCH)), a demodulation reference signal (DMRS), a phase tracking reference signal (PTRS), a tracking reference signal (TRS), and a channel state information (CSI) reference signal (CSI-RS), among other examples. A downlink signal carrying control information or data may be transmitted via a downlink channel. Downlink channels may include one or more control channels for transmitting control information and one or more data channels for transmitting data. Downlink reference signals may be transmitted in addition to, or multiplexed with, downlink control channel communications and/or downlink data channel communications. A downlink control channel may be specifically used to transmit DCI from a network node 110 to a UE 120. DCI generally contains the information the UE 120 needs to identify RBs in a subsequent subframe and how to decode them, including a modulation and coding scheme (MCS) or redundancy version parameters. Different DCI formats carry different information, such as scheduling information in the form of downlink or uplink grants, slot formal indicators (SFIs), preemption indicators (PIs), transmit power control (TPC) commands, hybrid automatic repeat request (HARQ) information, new data indicators (NDIs), among other examples. A downlink data channel may be used to transmit downlink data (for example, user data associated with a UE 120) from a network node 110 to a UE 120. Downlink control channels may include physical downlink control channels (PDCCHs), and downlink data channels may include physical downlink shared channels (PDSCHs). Control information or data communications may be transmitted on a PDCCH and PDSCH, respectively. For example, a PDCCH can carry DCI, while a PDSCH can carry a MAC control element (MAC-CE), an RRC message, or user data, among other examples. Each PDSCH may carry one or more transport blocks (TBs) of data.

As used herein, an uplink signal may include a reference signal, control information, or data. For example, uplink reference signals include a sounding reference signal (SRS), a PTRS, and a DMRS, among other examples. An uplink signal carrying control information or data may be transmitted via an uplink channel. An uplink channel may include one or more control channels for transmitting control information and one or more data channels for transmitting data. Uplink reference signals may be transmitted in addition to, or multiplexed with, uplink control channel communications and/or uplink data channel communications. An uplink control channel may be specifically used to transmit uplink control information (UCI) from a UE 120 to a network node 110. An uplink data channel may be used to transmit uplink data (for example, user data associated with a UE 120) from a UE 120 to a network node 110. Uplink control channels may include physical uplink control channels (PUCCHs), and uplink data channels may include physical uplink shared channels (PUSCHs). Control information or data communications may be transmitted on a PUCCH and PUSCH, respectively. For example, a PUCCH can carry UCI, while a PUSCH can carry a MAC-CE, an RRC message, or user data, among other examples. UCI can include a scheduling request (SR), HARQ feedback information (for example, a HARQ acknowledgement (ACK) indication or a HARQ negative acknowledgement (NACK) indication), uplink power control information (for example, an uplink TPC parameter), and/or CSI, among other examples. CSI can include a channel quality indicator (CQI) (indicative of downlink channel conditions to facilitate selection of transmission parameters, such as an MCS, by a network node 110), a precoding matrix indicator (PMI), a CSI-RS resource indicator (CRI) (for example, indicative of a beam used to transmit a CSI-RS), an SS/PBCH resource block indicator (SSBRI) (for example, indicative of a beam used to transmit an SSB), a layer indicator (LI), a rank indicator (RI), and/or measurement information (for example, a layer 1 (L1)- reference signal received power (RSRP) parameter, a received signal strength indicator (RSSI) parameter, a reference signal received quality (RSRQ) parameter, among other examples) which can be used for beam management, among other examples. Each PUSCH may carry one or more TBs of data.

The information (for example, data, control information, or reference signal information) transmitted by a network node 110 to a UE 120, or vice versa, may be represented as a sequence of binary bits that are mapped (for example, modulated) to an analog signal waveform (for example, a discrete Fourier transform (DFT)-spread-orthogonal frequency division multiplexing (OFDM) (DFT-s-OFDM) waveform or a CP-OFDM waveform) that is transmitted by the network node 110 or UE 120 over a wireless communication channel. In some examples, the network node 110 or the UE 120 (for example, using the processing system 145 or the processing system 140, respectively) may select an MCS (for example, an order of quadrature amplitude modulation (QAM), such as 64-QAM, 128-QAM, or 256-QAM, among other examples) for a downlink signal or an uplink signal. For example, the network node 110 may select an MCS for a downlink signal in accordance with UCI received from the UE 120. The network node 110 may transmit, to the UE 120, an indication of the selected MCS for the downlink signal, such as via DCI that schedules the downlink signal. As another example, the network node 110 may transmit, and the UE 120 may receive, an indication of an MCS to be applied for the one or more uplink signals, such as via DCI scheduling transmission of the one or more uplink signals.

The network node 110 or the UE 120 (such as by using the processing system 145 or the processing system 140, respectively, and/or one or more coupled modems) may perform signal processing on the information (such as filtering, amplification, modulation, digital-to-analog conversion, an IFFT operation, multiplexing, interleaving, mapping, and/or encoding, among other examples) to generate a processed signal in accordance with the selected MCS. In some examples, the network node 110 or the UE 120 (for example, using the processing system 145 or the processing system 140, respectively, and/or one or more coupled encoders or modems) may perform a channel coding operation or a forward error correction (FEC) operation to control errors in transmitted information. For example, the network node 110 or the UE 120 may perform an encoding operation to generate encoded information (such as by selectively introducing redundancy into the information, typically using an error correction code (ECC), such as a polar code or a low-density parity-check (LDPC) code). The network node 110 or the UE 120 (for example, using the processing system 145 and/or one or more modems) may further perform spatial processing (for example, precoding) on the encoded information to generate one or more processed or precoded signals for downlink or uplink transmission, respectively. In some examples, the network node 110 or the UE 120 may perform codebook-based precoding or non-codebook-based precoding. Codebook-based precoding may involve selecting a precoder (for example, a precoding matrix) using a codebook. For example, the network node 110 may provide precoding information indicating which precoder, defined by the codebook, is to be used by the UE 120. Non-codebook-based precoding may involve selecting or deriving a precoder based on, or otherwise associated with, one or more downlink or uplink signal measurements. The network node 110 or the UE 120 may transmit the processed downlink or uplink signals, respectively, via one or more antennas.

The network node 110 or the UE 120 may receive uplink signals or downlink signals, respectively, via one or more antennas. The network node 110 or the UE 120 (for example, using the processing system 145 or the processing system 140, respectively, and/or one or more coupled modems) may perform signal processing (for example, in accordance with the MCS) on the received uplink or downlink signals, respectively (such as filtering, amplification, demodulation, analog-to-digital conversion, an FFT operation, demultiplexing, deinterleaving, de-mapping, equalization, interference cancellation, and/or decoding, among other examples), to map the received signal(s) to a sequence of binary bits (for example, received information) that estimates the information transmitted by the network node 110 or the UE 120 via the downlink or uplink signals. The network node 110 or the UE 120 (for example, using the processing system 145 or the processing system 140, respectively, and/or a coupled decoder or one or more modems) may decode the received information (such as by using an ECC, a decoding operation, and/or an FEC operation) to detect errors and/or correct bit errors in the received information to generate decoded information. The decoded information may estimate the information transmitted via the downlink or uplink signals.

In some examples, a UE 120 and a network node 110 may perform MIMO communication. “MIMO” generally refers to transmitting or receiving multiple signals (such as multiple layers or multiple data streams) simultaneously over the same time and frequency resources. MIMO techniques generally exploit multipath propagation. A network node 110 and/or UE 120 may communicate using massive MIMO, multi-user MIMO, or single-user MIMO, which may involve rapid switching between beams or cells. For example, the amplitudes and/or phases of signals transmitted via antenna elements and/or sub-elements may be modulated and shifted relative to each other (such as by manipulating a phase shift, a phase offset, and/or an amplitude) to generate one or more beams, which is referred to as beamforming. For example, the network node 110b may generate one or more beams 160a, and the UE 120b may generate one or more beams 160b. The term “beam” may refer to a directional transmission of a wireless signal toward a receiving device or otherwise in a desired direction, a directional reception of a wireless signal from a transmitting device or otherwise in a desired direction, a direction associated with a directional transmission or directional reception, a set of directional resources associated with a signal transmission or signal reception (for example, an angle of arrival, a horizontal direction, and/or a vertical direction), a set of parameters that indicate one or more aspects of a directional signal, a direction associated with the signal, and/or a set of directional resources associated with the signal, among other examples.

MIMO may be implemented using various spatial processing or spatial multiplexing operations. In some examples, MIMO may include a massive MIMO technique which may be associated with an increased (for example, “massive”) quantity of antennas at the network node 110 and/or at the UE 120, such as in a network implementing mmWave technology. Massive MIMO may improve communication reliability by enabling a network node 110 and/or a UE 120 to communicate the same data across different propagation (or spatial) paths. In some examples, MIMO may support simultaneous transmission to multiple receivers, referred to as multi-user MIMO (MU-MIMO). Some RATs may employ MIMO techniques, such as multi-TRP (mTRP) operation (including redundant transmission or reception on multiple TRPs), reciprocity in the time domain or the frequency domain, single-frequency-network (SFN) transmission, or non-coherent joint transmission (NC-JT).

To support MIMO techniques, the network node 110 and the UE 120 may perform one or more beam management operations, such as an initial beam acquisition operation, one or more beam refinement operations, and/or a beam recovery operation. For example, an initial beam acquisition operation may involve the network node 110 transmitting signals (for example, SSBs, CSI-RSs, or other signals) via respective beams (for example, of the beams 160a of the network node 110) and the UE 120 receiving and measuring the signal(s) via respective beams of multiple beams (for example, from the beams 160b of the UE 120) to identify a best beam (or beam pair) for communication between the UE 120 and the network node 110. For example, the UE 120 may transmit an indication (for example, in a message associated with a random access channel (RACH) operation) of a (best) identified beam of the network node 110 (for example, by indicating an SSBRI or other identifier associated with the beam). A beam refinement operation may involve a first device (for example, the UE 120 or the network node 110) transmitting signal(s) via a subset of beams (for example, identified based on, or otherwise associated with, measurements reported as part of one or more other beam management operations). A second device (for example, the network node 110 or the UE 120) may receive the signal(s) via a single beam (for example, to identify the best beam for communication from the subset of beams). The beam(s) may be identified via one or more spatial parameters, such as a transmission configuration indicator (TCI) state and/or a quasi co-location (QCL) parameter, among other examples. The network node 110 and the UE 120 may increase reliability and/or achieve efficiencies in throughput, signal strength, and/or other signal properties for massive MIMO operations by performing the beam management operations.

Some aspects and techniques as described herein may be implemented, at least in part, using an artificial intelligence (AI) program (for example, referred to herein as an “AI/ML model”), such as a program that includes a machine learning (ML) model and/or an artificial neural network (ANN) model. The AI/ML model may be deployed at one or more devices 165 (for example, a network node 110 and/or UEs 120). For example, the one or more devices 165 may include a UE 120 (for example, the processing system 140), a network node 110 (for example, the processing system 145), one or more servers, and/or one or more components of a cloud computing network, among other examples. In some examples, the AI/ML model (or an instance of the AI/ML model) may be deployed at multiple devices (for example, a first portion of the AI/ML model may be deployed at a UE 120 and a second portion of the AI/ML model may be deployed at a network node 110). In other examples, a first AI/ML model may be deployed at a UE 120 and a second AI/ML model may be deployed at a network node 110. The AI/ML model(s) may be configured to enhance various aspects of the wireless communication network 100. For example, the AI/ML model(s) may be trained to identify patterns or relationships in data corresponding to the wireless communication network 100, a device, and/or an air interface, among other examples. The AI/ML model(s) may support operational decisions relating to one or more aspects associated with wireless communications devices, networks, or services.

A network node 110 or a UE 120 operating in a half-duplex mode may perform only one of transmission or reception during particular time resources, such as during particular slots, symbols, or other time periods. In various examples, some of the network nodes 110 and the UEs 120 of the wireless communication network 100 may be configured for full-duplex operation in addition to half-duplex operation. In full-duplex operation, a network node 110 or a UE 120 operating in a full-duplex (for example, SBFD) mode can transmit and receive communications concurrently (for example, in the same time resources). For example, as shown in FIG. 1, the network node 110b may operate in the full-duplex mode. The network node 110b may concurrently receive uplink communications from the UE 120b and transmit downlink communications to the UE 120c. By operating in a full-duplex mode, network nodes 110 and/or UEs 120 may generally increase the capacity of the network and the radio access link. In some examples, full-duplex operation may involve frequency division duplexing (FDD), in which downlink transmissions of the network node 110b are performed in a first frequency band or on a first component carrier and transmissions of the UE 120b are performed in a second frequency band or on a second component carrier different than the first frequency band or the first component carrier, respectively. In some examples, full-duplex operation may be enabled for a UE 120 but not for a network node 110. For example, a UE 120 may simultaneously transmit an uplink transmission to a first network node 110 and receive a downlink transmission from a second network node 110 in the same time resources. In some other examples, full-duplex operation may be enabled for a network node 110 but not for a UE 120. For example, the network node 110b may simultaneously transmit a downlink transmission to a first UE 120 (for example, the UE 120c) and receive an uplink transmission from a second UE 120 (for example, the UE 120b) in the same time resources. In some other examples, full-duplex operation may be enabled for both a network node 110 and a UE 120.

In some aspects, the UE 120 may include a communication manager 150. As described in more detail elsewhere herein, the communication manager 150 may receive, from a network node, an SBFD frequency resource configuration indicating a first set of frequency resources for network node full-duplex communications, wherein the SBFD frequency resource configuration indicates a first guard band size of the first set of frequency resources; determine a second set of frequency resources for UE full-duplex communications in accordance with the SBFD frequency resource configuration, wherein the second set of frequency resources corresponds to a second guard band size; and perform full-duplex communications via the second set of frequency resources. Additionally, or alternatively, the communication manager 150 may perform one or more other operations described herein.

In some aspects, the network node 110 may include a communication manager 155. As described in more detail elsewhere herein, the communication manager 155 may transmit , to a UE, a first SBFD frequency resource configuration indicating a first set of frequency resources that are for network node full-duplex communications, wherein the SBFD frequency resource configuration indicates a first guard band size of the first set of frequency resources; transmit , to the UE, an indication associated with a second set of frequency resources that are for UE full-duplex communications, wherein the second set of frequency resources corresponds to a second guard band size; and perform full-duplex communications via the first set of frequency resources. Additionally, or alternatively, the communication manager 155 may perform one or more other operations described herein.

FIG. 2 is a diagram illustrating an example disaggregated network node architecture 200, in accordance with the present disclosure. One or more components of the example disaggregated network node architecture 200 may be, may include, or may be included in one or more network nodes (such one or more network nodes 110). The disaggregated network node architecture 200 may include a CU 210 that can communicate directly with a core network 220 via a backhaul link, or that can communicate indirectly with the core network 220 via one or more disaggregated control units, such as a non-real-time (Non-RT) RAN intelligent controller (RIC) 250 associated with a Service Management and Orchestration (SMO) Framework 260 and/or a near-real-time (Near-RT) RIC 270 (for example, via an E2 link). The CU 210 may communicate with one or more DUs 230 via respective midhaul links, such as via F1 interfaces. Each of the DUs 230 may communicate with one or more RUs 240 via respective fronthaul links. Each of the RUs 240 may communicate with one or more UEs 120 via respective RF access links. In some deployments, a UE 120 may be simultaneously served by multiple RUs 240.

Each of the components of the disaggregated network node architecture 200, including the CUs 210, the DUs 230, the RUs 240, the Near-RT RICs 270, the Non-RT RICs 250, and the SMO Framework 260, may include one or more interfaces or may be coupled with one or more interfaces for receiving or transmitting signals, such as data or information, via a wired or wireless transmission medium.

In some aspects, the CU 210 may be logically split into one or more CU user plane (CU-UP) units and one or more CU control plane (CU-CP) units. A CU-UP unit may communicate bidirectionally with a CU-CP unit via an interface, such as the E1 interface when implemented in an O-RAN configuration. The CU 210 may be deployed to communicate with one or more DUs 230, as necessary, for network control and signaling. Each DU 230 may correspond to a logical unit that includes one or more base station functions to control the operation of one or more RUs 240. For example, a DU 230 may host various layers, such as an RLC layer, a MAC layer, or one or more PHY layers, such as one or more high PHY layers or one or more low PHY layers. Each layer (which also may be referred to as a module) may be implemented with an interface for communicating signals with other layers (and modules) hosted by the DU 230, or for communicating signals with the control functions hosted by the CU 210. Each RU 240 may implement lower layer functionality. In some aspects, real-time and non-real-time aspects of control and user plane communication with the RU(s) 240 may be controlled by the corresponding DU 230.

The SMO Framework 260 may support RAN deployment and provisioning of non-virtualized and virtualized network elements. For non-virtualized network elements, the SMO Framework 260 may support the deployment of dedicated physical resources for RAN coverage requirements, which may be managed via an operations and maintenance interface, such as an O1 interface. For virtualized network elements, the SMO Framework 260 may interact with a cloud computing platform (such as an open cloud (O-Cloud) platform 290) to perform network element life cycle management (such as to instantiate virtualized network elements) via a cloud computing platform interface, such as an O2 interface. A virtualized network element may include, but is not limited to, a CU 210, a DU 230, an RU 240, a non-RT RIC 250, and/or a Near-RT RIC 270. In some aspects, the SMO Framework 260 may communicate with a hardware aspect of a 4G RAN, a 5G NR RAN, and/or a 6G RAN, such as an open eNB (O-eNB) 280, via an O1 interface. Additionally or alternatively, the SMO Framework 260 may communicate directly with each of one or more RUs 240 via a respective O1 interface. In some deployments, this configuration can enable each DU 230 and the CU 210 to be implemented in a cloud-based RAN architecture, such as a vRAN architecture.

The Non-RT RIC 250 may include or may implement a logical function that enables non-real-time control and optimization of RAN elements and resources, AI/ML workflows including model training and updates, and/or policy-based guidance of applications and/or features in the Near-RT RIC 270. The Non-RT RIC 250 may be coupled to or may communicate with (such as via an A1 interface) the Near-RT RIC 270. The Near-RT RIC 270 may include or may implement a logical function that enables near-real-time control and optimization of RAN elements and resources via data collection and actions via an interface (such as via an E2 interface) connecting one or more CUs 210, one or more DUs 230, and/or an O-eNB 280 with the Near-RT RIC 270.

In some aspects, to generate AI/ML models to be deployed in the Near-RT RIC 270, the Non-RT RIC 250 may receive parameters or external enrichment information from external servers. Such information may be utilized by the Near-RT RIC 270 and may be received at the SMO Framework 260 or the Non-RT RIC 250 from non-network data sources or from network functions. In some examples, the Non-RT RIC 250 or the Near-RT RIC 270 may tune RAN behavior or performance. For example, the Non-RT RIC 250 may monitor long-term trends and patterns for performance and may employ AI/ML models to perform corrective actions via the SMO Framework 260 (such as reconfiguration via an O1 interface) or via creation of RAN management policies (such as A1 interface policies).

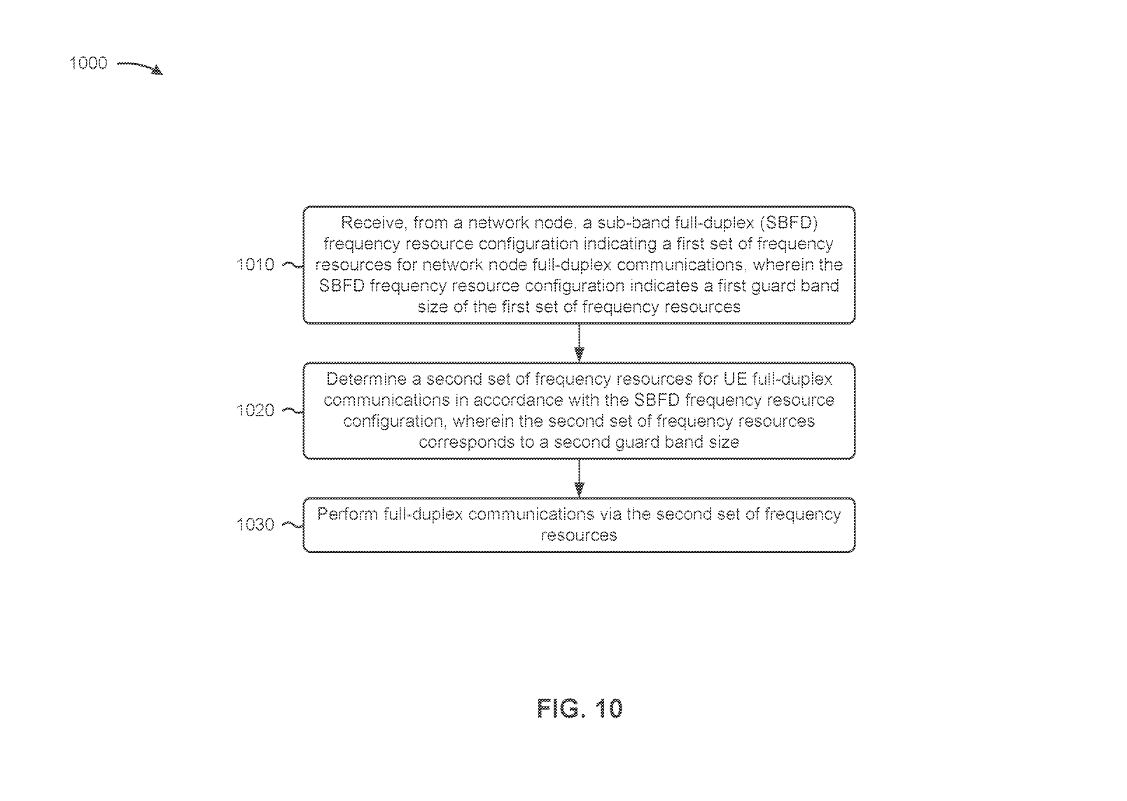

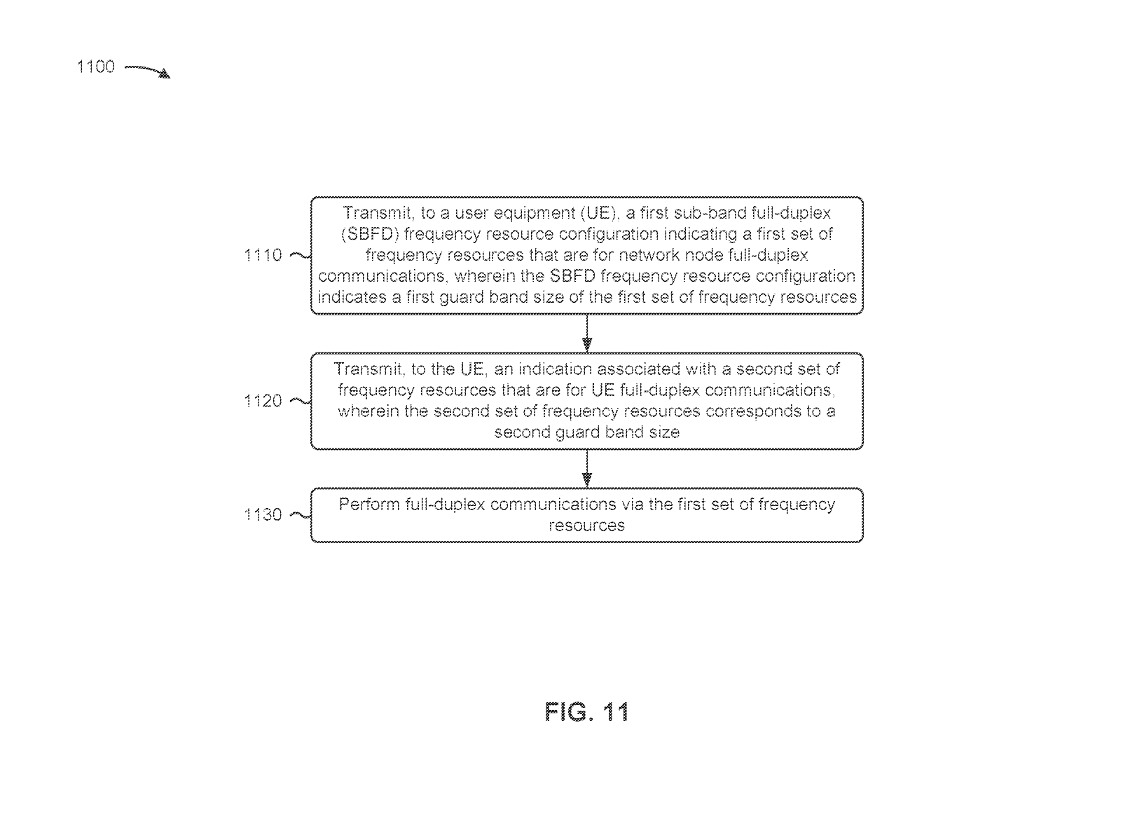

The network node 110, the processing system 145 of the network node 110, the UE 120, the processing system 140 of the UE 120, the CU 210, the DU 230, the RU 240, or any other component(s) of FIG. 1 and/or FIG. 2 may implement one or more techniques or perform one or more operations associated with determining frequency domain resources for full-duplex UE communications, as described in more detail elsewhere herein. For example, the processing system 145 of the network node 110, the processing system 140 of the UE 120, the CU 210, the DU 230, or the RU 240 may perform or direct operations of, for example, process 1000 of FIG. 10, process 1100 of FIG. 11, or other processes as described herein (alone or in conjunction with one or more other processors). Memory of the network node 110 may store data and program code (or instructions) for the network node 110, the CU 210, the DU 230, or the RU 240. In some examples, the memory of the network node 110 may store data relating to a UE 120, such as RRC state information or a UE context. Memory of a UE 120 may store data and program code (or instructions) for the UE 120, such as context information. In some examples, the memory of the UE 120 or the memory of the network node 110 may include a non-transitory computer-readable medium storing a set of instructions for wireless communication. For example, the set of instructions, when executed by one or more processors (for example, of the processing system 145 or the processing system 140) of the network node 110, the UE 120, the CU 210, the DU 230, or the RU 240, may cause the one or more processors to perform process 1000 of FIG. 10, process 1100 of FIG. 11, or other processes as described herein. In some examples, executing instructions may include running the instructions, converting the instructions, compiling the instructions, and/or interpreting the instructions, among other examples.

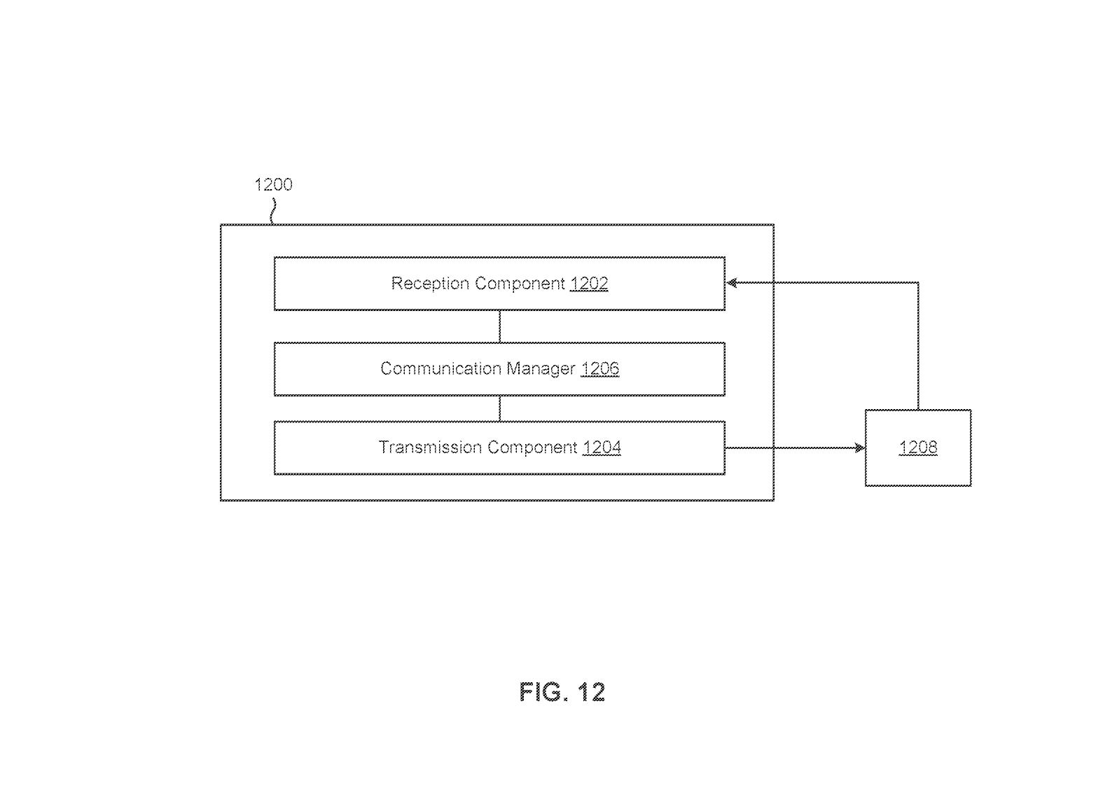

In some aspects, the UE includes means for receiving, from a network node, an SBFD frequency resource configuration indicating a first set of frequency resources for network node full-duplex communications, wherein the SBFD frequency resource configuration indicates a first guard band size of the first set of frequency resources; means for determining a second set of frequency resources for UE full-duplex communications in accordance with the SBFD frequency resource configuration, wherein the second set of frequency resources corresponds to a second guard band size; and/or means for performing full-duplex communications via the second set of frequency resources. The means for the UE to perform operations described herein may include, for example, one or more of communication manager 150, processing system 140, a radio, one or more RF chains, one or more transceivers, one or more antennas, one or more modems, a reception component (for example, reception component 1202 depicted and described in connection with FIG. 12), and/or a transmission component (for example, transmission component 1204 depicted and described in connection with FIG. 12), among other examples.

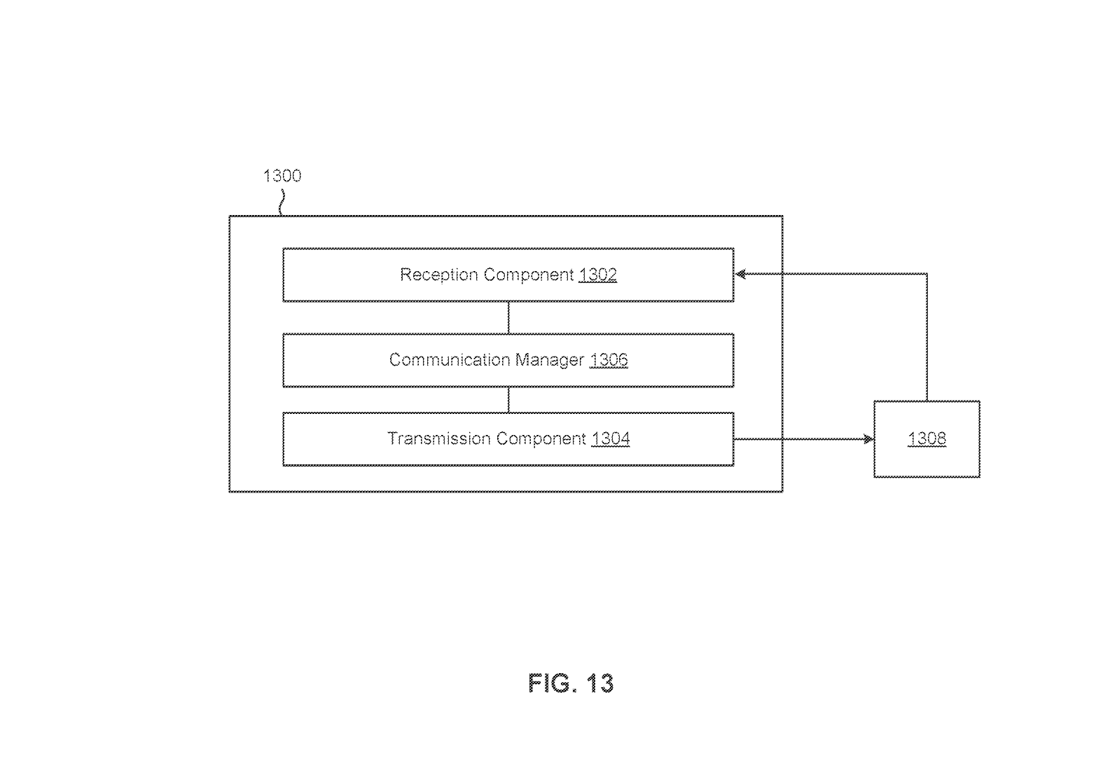

In some aspects, the network node includes means for transmitting, to a UE, a first SBFD frequency resource configuration indicating a first set of frequency resources that are for network node full-duplex communications, wherein the SBFD frequency resource configuration indicates a first guard band size of the first set of frequency resources; means for transmitting, to the UE, an indication associated with a second set of frequency resources that are for UE full-duplex communications, wherein the second set of frequency resources corresponds to a second guard band size; and/or means for performing full-duplex communications via the first set of frequency resources. The means for the network node to perform operations described herein may include, for example, one or more of communication manager 155, processing system 145, a radio, one or more RF chains, one or more transceivers, one or more antennas, one or more modems, a reception component (for example, reception component 1302 depicted and described in connection with FIG. 13), and/or a transmission component (for example, transmission component 1304 depicted and described in connection with FIG. 13), among other examples.

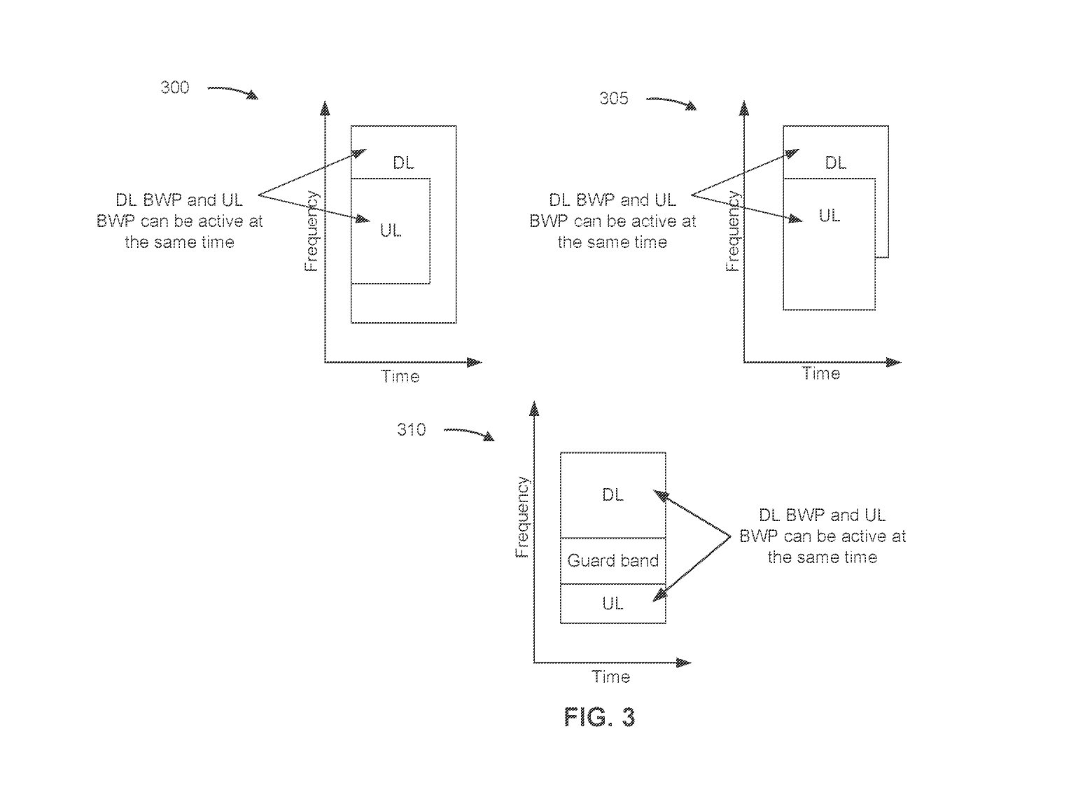

FIG. 3 is a diagram illustrating examples 300, 305, and 310 of full-duplex communication in a wireless network, in accordance with the present disclosure. “Full-duplex communication” in a wireless network refers to simultaneous bi-directional communication between devices in the wireless network. For example, a UE and/or a network node operating in a full-duplex mode may transmit an uplink communication and receive a downlink communication at the same time (e.g., in the same slot or the same symbol). “Half-duplex communication” in a wireless network refers to unidirectional communications (e.g., only downlink communication or only uplink communication) between devices at a given time (e.g., in a given slot or a given symbol).

As shown in FIG. 3, examples 300 and 305 show of in-band full-duplex (IBFD) communication. In IBFD, a UE and/or a network node may transmit an uplink communication to another device and may receive a downlink communication from the other device on the same time and frequency resources. As shown in example 300, in a first example of IBFD, the time and frequency resources for uplink communication may fully overlap with the time and frequency resources for downlink communication. As shown in example 305, in a second example of IBFD, the time and frequency resources for uplink communication may partially overlap with the time and frequency resources for downlink communication.

As further shown in FIG. 3, example 310 shows an example of SBFD communication, which may also be referred to as “sub-band frequency division duplex (SBFDD)” or “flexible duplex.” In SBFD, a UE and/or a network node may transmit an uplink communication to another device and receive a downlink communication from the other device at the same time, but on different frequency resources. For example, the different frequency resources may be sub-bands of a frequency band, such as a time division duplexing band. In this case, the frequency resources used for downlink communication may be separated from the frequency resources used for uplink communication, in the frequency domain, by a guard band.

The guard band may reduce a likelihood of self-interference at the UE and/or the network node caused by downlink communications and uplink communications in SBFD communications. For example, a network node and/or a UE may experience self-interference when simultaneous uplink and downlink communications occur via frequency resources that are contiguous or relatively close in frequency to each other, as shown in example 310. By separating frequency resources of SBFD time resource with a guard band, the likelihood and/or effects of self-interference are reduced. For example, a downlink frequency resource in the SBFD slot may be separated (e.g., in frequency) from an uplink frequency resource in the SBFD slot by a guard band, which may function to reduce self-interference and improve latency and uplink coverage. The gap may be a frequency offset or a frequency gap (e.g., guard band) between frequency resources in the same SBFD slot.

As indicated above, FIG. 3 is provided as an example. Other examples may differ from what is described with respect to FIG. 3.

FIG. 4 is a diagram illustrating an example 400 of a full-duplex zone, a non-FD zone, and self-interference associated with full-duplex communications, in accordance with the present disclosure. As shown, example 400 includes a network node (e.g., network node 110), a UE1 (e.g., UE 120), and a UE2 (e.g., another UE 120). In some aspects, the network node may be capable of full-duplex communication. Full-duplex communication may include a contemporaneous uplink and downlink communication using the same resources. For example, the network node may perform a downlink (DL) transmission to a UE1 (shown by reference number 410) and may receive an uplink (UL) transmission from a UE2 (shown by reference number 420) using the same frequency resources and at least partially overlapping in time.

As shown by reference number 430, the DL transmission from the network node may self-interfere with the UL transmission to the network node. This may be caused by a variety of factors, such as the higher transmit power for the DL transmission (as compared to the UL transmission) and/or radio frequency bleeding. Furthermore, as shown by reference number 440, the UL transmission to the network node from the UE2 may interfere with the DL transmission from the network node to the UE1, thereby diminishing DL performance of the UE1.

A full-duplex zone is shown by reference number 450 and a non-FD zone is shown by reference number 460. A "full-duplex zone" may refer to a time period and/or a frequency region in which a wireless communication device (e.g., a network node 110, a UE 120, a node, or a similar device) performs full-duplex communication, and a "non-FD zone" may refer to a time period and/or a frequency region in which a wireless communication device performs non-FD communication. The full-duplex zone may be associated with higher self-interference, and therefore a lower signal-to-interference-plus-noise ratio (SINR), than the non-FD zone.

In some examples, full-duplex communications may be supported by different antenna panels of a device. For example, a first antenna panel of the device may communicate uplink and/or downlink communications while a second antenna panel of the device may communicate downlink and/or uplink communications. The physical distance between an uplink panel and a downlink panel may mitigate the effects of interference. The network node performing full-duplex communications may be relatively effective at mitigating interference using panel separation because the network node may be able to use panels that have a relatively large separation due to physical properties associated with the network node, such as physical size, spatial allocation, among other examples. Thus, because uplink and/or downlink antenna panels may have a relatively large physical separation, the network node may be able to implement a small guard band size to perform full-duplex communications while achieving a baseline quality of communications and/or effectively mitigate self-interference.

As indicated above, FIG. 4 is provided as an example. Other examples may differ from what is described with respect to FIG. 4.

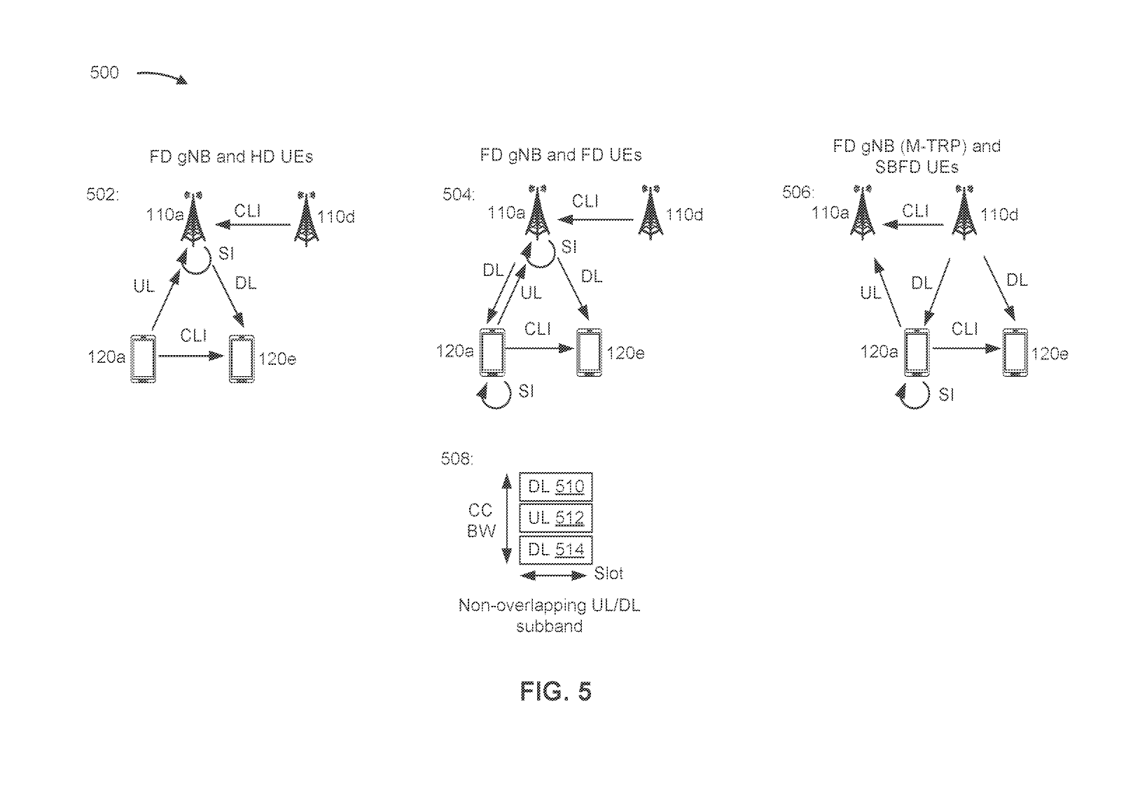

FIG. 5 is a diagram illustrating examples 500 of full-duplex communications, in accordance with the present disclosure.

As shown by reference number 502, a full-duplex network node (e.g., network node 110a) may communicate with half-duplex UEs. The full-duplex network node may be subjected to cross-link interference from another full-duplex network node (e.g., network node 110d). The cross-link interference from the other full-duplex network node may be inter-network-node cross-link interference. The full-duplex network node may experience self-interference. The full-duplex network node may receive an uplink transmission from a first half-duplex UE (e.g., UE 120a), and the full-duplex network node may transmit a downlink transmission to a second half-duplex UE (e.g., UE 120e). The full-duplex network node may receive the uplink transmission and transmit the downlink transmission on the same slot (e.g., a simultaneous reception/transmission). The second half-duplex UE may be subjected to cross-link interference from the first half-duplex UE (e.g., inter-UE cross-link interference).

As shown by reference number 504, a full-duplex network node (e.g., network node 110a) may communicate with full-duplex UEs. The full-duplex network node may be subjected to cross-link interference from another full-duplex network node (e.g., network node 110d). The full-duplex network node may experience self-interference. The full-duplex network node may transmit a downlink transmission to a first full-duplex UE (e.g., UE 120a), and the full-duplex network node may receive an uplink transmission from the first full-duplex UE at the same time as the downlink transmission. The full-duplex network node may transmit a downlink transmission to a second full-duplex UE (e.g., UE 120e). The second half-duplex UE may be subjected to cross-link interference from the first half-duplex UE. The first UE may experience self-interference.

As shown by reference number 506, a first full-duplex network node (e.g., network node 110a), which may be associated with multiple TRPs, may communicate with SBFD UEs. The first full-duplex network node may be subjected to cross-link interference from a second full-duplex network node (e.g., network node 110s). The first full-duplex network node may receive an uplink transmission from a first SBFD UE (e.g., UE 120a). The second full-duplex network node may transmit downlink transmissions to both the first SBFD UE and a second SBFD UE (e.g., UE 120e). The second SBFD UE may be subjected to cross-link interference from the first SBFD UE. The first SBFD UE may experience self-interference.

As shown by reference number 508, an SBFD slot may be associated with a non-overlapping uplink/downlink sub-band. The SBFD slot may be associated with a simultaneous transmission/reception of a downlink/uplink on a sub-band basis. Within a component carrier bandwidth, an uplink resource 512 may be between, in a frequency domain, a first downlink resource 510 and a second downlink resource 514. The first downlink resource 510, the second downlink resource 514, and the uplink resource 512 may all be associated with the same time.

SBFD communications may be supported by the use of different antenna panels for different communication links to mitigate interference. For example, a first antenna panel of a wireless communications device may communicate uplink and/or downlink communications while a second antenna panel of a wireless communications device may communicate downlink and/or uplink communications. The physical distance between an uplink panel and a downlink panel may mitigate the effects of interference (e.g., reduce leakage) by increasing spatial domain isolation, thus reducing the likelihood and/or effects of self-interference. A network node performing full-duplex communications may be relatively effective at mitigating interference using panel separation because the network node may be able to use panels that have a relatively large separation due to physical properties associated with the network node, such as physical size, spatial allocation, among other examples. Thus, because uplink and/or downlink antenna panels may have a relatively large physical separation, the network node may be able to implement a small guard band size to perform full-duplex communications while achieving a baseline quality of communications and/or effectively mitigate self-interference. Because a network node may be relatively larger (e.g., be associated with more design flexibility, include more panels, include a larger spatial distribution of panels) than a UE, a physical separation between antenna panels of the network node may be larger than a physical separation of antenna panels at a UE. In some examples, due to the size of a UE, implementing separate uplink and downlink panels may not be practical at a UE, and as a result, the UE may experience more interference when performing full-duplex communications using a same guard band size as a network node. For example, because uplink and/or downlink antenna panels may have a relatively large physical separation, the network node may use a relatively narrow guard band size (e.g., frequency range, span, and/or gap of a guard band) to perform SBFD communications to achieve a baseline quality of communications and/or effectively mitigate self-interference.

However, for an SBFD-enabled UE, the physical separation between uplink and downlink antenna panels (e.g., which may be little to no separation) may be relatively small. For example, even though an SBFD-enabled UE may include features, such as separate Tx/Rx antennas and/or panels, a single shared antenna with an SBFD-considered circulator/duplexer design, a Tx/Rx analog filter, an analog interference canceller, an Rx filter, a digital interference canceller (e.g., implementing kernel generation from Tx samples and/or feedback cancellation to account for post non-linearity), blocker component, and/or Rx de-sensitivity, all of which may assist in mitigating interference associated with SBFD communications—the UE may still be relatively less effective as using physical properties and processing to mitigate interference than a network node using a same guard band size. Thus, the UE may need to mitigate more self-interference to achieve a baseline quality of communications and/or communicate successfully in the presence of self-interference.

As indicated above, FIG. 5 is provided as an example. Other examples may differ from what is described with regard to FIG. 5.

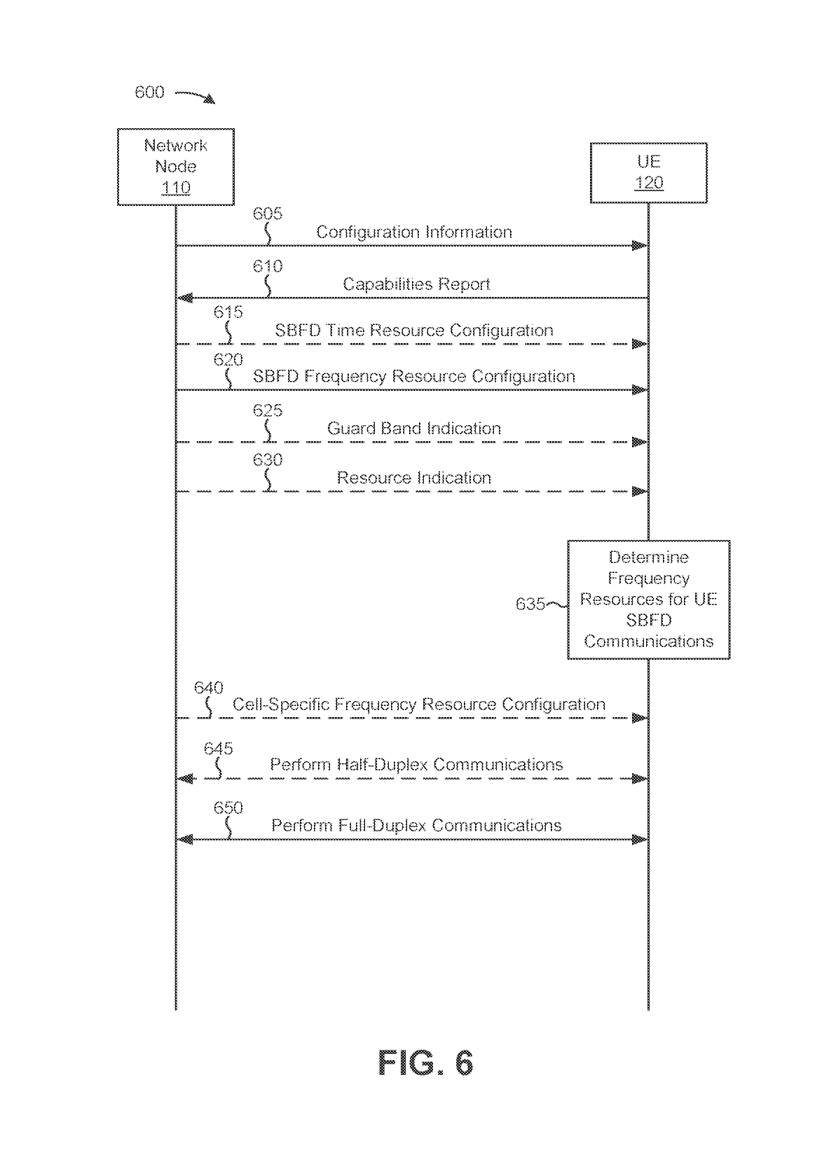

FIG. 6 is a diagram of an example 600 associated with UE SBFD resource determination, in accordance with the present disclosure. As shown in FIG. 6, a network node 110 (e.g., a network node 110 as described with reference to any of FIGS. 1-5, a CU, a DU, and/or an RU) may communicate with a UE 120 (e.g., a UE 120 as described with reference to any of FIGS. 1-5). In some aspects, the network node 110 and the UE 120 may be part of a wireless network (e.g., wireless network 100). The UE 120 and the network node 110 may have established a wireless connection prior to operations shown in FIG. 6. In some aspects, the network node 110 and/or the UE 120 may be SBFD-capable wireless devices.

As shown by reference number 605, the network node 110 may transmit, and the UE 120 may receive, configuration information. In some aspects, the UE 120 may receive the configuration information via one or more of system information (e.g., a master information block (MIB) and/or a system information block (SIB), among other examples), RRC signaling, one or more MAC-CEs, and/or DCI, among other examples.

In some aspects, the configuration information may indicate one or more candidate configurations and/or communication parameters. In some aspects, the one or more candidate configurations and/or communication parameters may be selected, activated, and/or deactivated by a subsequent indication. For example, the subsequent indication may select a candidate configuration and/or communication parameter from the one or more candidate configurations and/or communication parameters. In some aspects, the subsequent indication (e.g., an indication described herein) may include a dynamic indication, such as one or more MAC CEs and/or one or more DCI messages, among other examples.

In some aspects, the configuration information may indicate that the UE is to perform SBFD communications via one or more time domain resources and/or frequency domain resources. In some aspects, because an SBFD-capable UE may benefit from implementing a larger guard band size (e.g., than a guard band associated with network node SBFD communications) to mitigate self-interference, the configuration information may indicate that the UE is to determine one or more frequency resources for UE SBFD communications that are different from frequency resources for network node SBFD communications (e.g., associated with a larger guard band size).

The UE 120 may configure itself based at least in part on the configuration information. In some aspects, the UE 120 may be configured to perform one or more operations described herein based at least in part on the configuration information.

In some aspects, the configuration information may include one or more SBFD configurations, such as an SBFD time resource configuration indicating time resources for UE and/or network node SBFD communications, and/ or an SBFD frequency resource configuration indicating frequency resources for UE and/or network node SBFD communications. In some aspects, such configurations may be received via additional signaling and/or messaging.

As shown by reference number 610, the UE 120 may transmit, and the network node 110 may receive, a capabilities report. The capabilities report may indicate whether the UE 120 supports a feature and/or one or more parameters related to the feature. For example, the capability information may indicate a capability and/or parameter for SBFD communications. As another example, the capabilities report may indicate a capability and/or parameter for determining and/or identifying frequency resources for SBFD communications. One or more operations described herein may be based on capability information of the capabilities report. For example, the UE 120 may perform a communication in accordance with the capability information, or may receive configuration information that is in accordance with the capability information. In some aspects, the capabilities report may indicate UE support for performing SBFD communications, and/or performing SBFD-aware communications (e.g., performing UE half-duplex communications with a network node performing full-duplex communications). In some aspects, the UE 120 may transmit, and the network node 110 may receive, an SBFD capability message indicating at least one capability of the UE 120. For example, the SBFD capability message may indicate a first baseline guard band (e.g., a second minimum guard band and/or guard band size) corresponding to a first quantity of frequency resources (e.g., network node SBFD frequency resources), and/or a second baseline guard band (e.g., a second minimum guard band and/or guard band size), different from the first baseline guard band, corresponding to a second quantity of frequency resources (e.g., network node SBFD frequency resources). In some aspects, the first baseline guard band may be smaller than the second baseline guard band. In some aspects, the at least one capability of the UE 120 corresponds to a subcarrier spacing associated with communications at the UE 120, and/or a frequency range associated with communications at the UE 120. For example, SBFD communications and/or a guard ban size may be associated with or specific to a subcarrier spacing and/or a frequency band.

In some aspects, the configuration information described in connection with reference number 605 and/or the capabilities report described in connection with reference number 610 may include information transmitted via multiple communications. Additionally, or alternatively, the network node 110 may transmit the configuration information, or a communication including at least a portion of the configuration information, before and/or after the UE 120 transmits the capabilities report. For example, the network node 110 may transmit a first portion of the configuration information before the capabilities report, the UE 12- may transmit at least a portion of the capabilities report, and the network node 110 may transmit a second portion of the configuration information after receiving the capabilities report.

As shown by reference number 615, in some examples, the UE 120 may transmit, and the network node 110 may receive, an SBFD time resource configuration. For example, the UE 120 may transmit, and the network node 110 may receive, an SBFD time resource configuration indicating a first set of one or more time resources that is for the network node full-duplex communications, and a second set of one or more time resources that is for the UE full-duplex communications.

In some aspects, each resource of the second set of one or more time resources may be associated with a same set of frequency resources. For example, each slot indicated for UE SBFD communications may be associated with a same set of sub-bands (e.g., a same frequency allocation for each SBFD-UE slots). In some aspects, a first resource of the second set of one or more time resources may be associated with a different set of frequency resources than a second resource of the second set of one or more time resources. For example, one or more slots indicated for UE SBFD communications may be associated with a different frequency allocation (e.g., set of sub-bands) than one or more other slots for UE SBFD communications. The time resources for UE SBFD communications may thus each be associated with a same frequency allocation and/or may be associated with different frequency allocations.

In some aspects, the second set of one or more time resources (e.g., time resources for UE SBFD communications) may be a subset of the first set of one or more time resources (e.g., time resources for network node SBFD communications). For example, the UE 120 may be enabled to perform SBFD communications in time resources in which the network node 110 is enabled to perform SBFD communications. In some aspects, the first set of one or more time resources may partially overlap with the second set of one or more time resources. For example, the UE 120 and the network node 110 may both be enabled to perform SBFD communications during at least one time resource. In some aspects, the first set of one or more time resources and the second set of one or more time resources are disjoint sets. For example, the UE 120 may be enabled to perform SBFD communications in time resources in which the network node 110 is not enabled to perform SBFD communications and/or the UE 120 may not be enabled to perform SBFD communications in time resources in which the network node 110 is enabled to perform SBFD communications.

In some aspects, a set of usable physical resource blocks associated with the SBFD time resource configuration may not include one or more physical resource blocks that at least partially overlap with at least one guard band associated with a first set of frequency resources (e.g., UE SBFD frequency resources) and/or a second set of frequency resources (e.g., UE SBFD frequency resources). For example, usable (e.g., supported for UE SBFD communications) physical resource blocks for SBFD-aware time resources may include the downlink and/or uplink physical resource blocks of the SBFD-aware slots (e.g., network node only SBFD slots) may not include physical resource blocks that overlap with the guard-bands of the SBFD-aware UE. In some aspects, a set of usable physical resource blocks associated with the SBFD time resource configuration may include one or more physical resource blocks that at least partially overlap with at least one resource of at least one of the first set of frequency resources and/or the second set of frequency resources. For example, usable (e.g., supported for UE SBFD communications) physical resource blocks for SBFD-aware time resources may include the downlink and/or uplink physical resource blocks that overlap with the downlink sub-band/s of the SBFD-aware slots.

In some aspects, the SBFD time resource configuration may indicate a third set of one or more time resources for network node SBFD communications and UE half-duplex communications.

As shown by reference number 620, the network node 110 may transmit, and the UE 120 may receive, an SBFD frequency resource configuration. For example, the network node 110 may transmit, and the UE 120 may receive an SBFD frequency resource configuration indicating a first set of frequency resources for network node full-duplex communications. In some aspects, the SBFD frequency resource configuration may indicate a first guard band size (e.g., a guard band size for network node full-duplex communications) of the first set of frequency resources. In some aspects, the SBFD frequency resource configuration may include a start and length indicator value including the first set of frequency resources and/or a second set of frequency resources (e.g., UE SBFD frequency resources).

As shown by reference number 625, in some aspects, the network node 110 may transmit, and the UE 120 may receive, a guard band indication. For example, the network node 110 may transmit, and the UE 120 may receive an indication of the one or more guard band extension values, and/or an indication of which guard band extension values of the one or more extension values correspond to which frequency resources of the first set of frequency resources. For example, the guard band indication may include an indication of a size of the guard band extension for downlink sub-bands and/or uplink sub-bands and/or may include an indication of which guard band extensions to apply to which sub-bands. In some aspects, the one or more guard band extension values may include a quantity of resource elements, a quantity of resource blocks, a quantity of resource block groups, and/or a quantity of megahertz.

As shown by reference number 630, in some aspects, the network node 110 may transmit, and the UE 120 may receive, a resource indication. For example, the network node 110 may transmit, and the UE 120 may receive an indication of the second set of frequency resources. In some aspects, the indication of the second set of resources may include a quantity of frequency resources. For example, the network node may indicate a quantity of uplink sub-bands and/or downlink sub-bands for UE SBFD communications. In some aspects, the indication of the second set of frequency resources may indicate a quantity of frequency resources that is less than a quantity of frequency resources of the first set of frequency resources. For example, the quantity of resources for network node SBFD communications may include three or more sub-bands and the quantity of resources for UE SBFD communications may include two or more sub-bands. In some aspects, the indication of the second set of resources may include a set of one or more guard bands associated with the second guard band size. For example, the indication may include a specific frequency range for each guard band and/or may indicate a size of each guard band for UE SBFD communications.

In some aspects, the indication of the second set of frequency resources may include a set of one or more guard bands associated with the second guard band size, where at least one guard band of the set of one or more guard bands overlaps with at least one resource of the first set of frequency resources. For example, if the indication includes the guard-bands, one of the guard-bands may span the entirety of a sub-band for network node SBFD communications. In some aspects, the guard band extension value may be greater than or equal to a frequency range of at least one resource of the first set of frequency resources. For example, if the indication includes one or more guard band extensions, the size of the extension may span the entirety of a sub-band for network node SBFD communications. In some aspects, the indication of the second set of frequency resources may include a bit map indicating that the second set of frequency resources includes a subset of the first set of frequency resources. For example, the indication may include an explicit indication of the sub-bands (e.g., indicating sub-bands to be removed and/or indicating remaining sub-bands for UE SBFD communications). In some aspects, a bit-map of [011] may indicate that the frequency resources for UE SBFD communications may include the second and third frequency resource for network node SBFD communications which may reduce signaling overhead when one of the network node SBFD sub-bands is removed for UE SBFD communications.

In some aspects, the UE 120 may receive a start and length indicator value including the first set of frequency resources and/or the second set of frequency resources.

As shown by reference number 635, the UE 120 may determine frequency resources for UE SBFD communications. For example, the UE 120 may determine a second set of frequency resources for UE full-duplex communications in accordance with the SBFD frequency resource configuration. In some aspects, the second set of frequency resources corresponds to a second guard band size. In some aspects, second guard band size is greater than the first guard band size.

In some aspects, the second set of frequency resources may include a quantity of frequency resources for uplink UE full-duplex communications and a quantity of frequency resources for downlink UE full-duplex communications. In some aspects, the second set of frequency resources for performing UE full-duplex communications may be the same for each UE in a cell associated with (e.g., serving) the UE 120 and/or the network node 110. For example, a frequency indication container associated with the second set of frequency resources may be cell-specific and may be the same for each UE. In some aspects, the second set of frequency resources may be specific to UE full-duplex communications associated with a cell (e.g., serving the UE 120 and/or associated with the network node 110) and may be different for each UE associated with the cell. For example, a frequency indication container associated with the second set of frequency resources may be cell-specific but may be different for each UE, and may be common for all bandwidth parts. In some aspects, the second set of frequency resources may be specific to UE full-duplex communications associated with a bandwidth part. For example, a frequency indication container associated with the second set of frequency resources may be defined per bandwidth part.

In some aspects an extension to the first guard band size (e.g., the SBFD-aware guard band, the network node guard band) may be applied to derive (e.g., calculate, identify, determine, configure) the guard band for SBFD-UE slots (e.g., the second set of SBFD time resources).

In some aspects, the first set of frequency resources includes a first subset of frequency resources for downlink full-duplex communications and a second subset of frequency resources for uplink full-duplex communications. In such aspects, determining the second set of frequency resources may include deriving the second set of frequency resources from the first set of frequency resources by applying a guard band extension value to the first guard band size to obtain the second guard band size and decrease a frequency range of each frequency resource of the first subset of frequency resources. For example, the guard band size extension may be applied to downlink sub-bands and as a result, downlink sub-bands for UE SBFD communications may be smaller (e.g., in frequency span and/or range) than downlink sub-bands for network node SBFD communications to accommodate the larger guard band size.

In some aspects, the first set of frequency resources includes the first subset of frequency resources for downlink full-duplex communications and the second subset of frequency resources for uplink full-duplex communications. In such aspects, determining the second set of frequency resources may include deriving the second set of frequency resources from the first set of frequency resources by applying a guard band extension value to the first guard band size to obtain the second guard band size and decrease a frequency range of each frequency resource of the second subset of frequency resources. For example, the guard band size extension may be applied to uplink sub-bands and as a result, uplink sub-bands for UE SBFD communications may be smaller (e.g., in frequency span and/or range) than uplink sub-bands for network node SBFD communications to accommodate the larger guard band size.

In some aspects, the first set of frequency resources includes the first subset of frequency resources for downlink full-duplex communications and the second subset of frequency resources for uplink full-duplex communications. In such aspects, determining the second set of frequency resources may include deriving the second set of frequency resources from the first set of frequency resources by applying a guard band extension value to the first guard band size to obtain the second guard band size and decrease a frequency range of each frequency resource of the first subset of frequency resources and the second subset of frequency resources. For example, the guard band size extension may be applied to uplink sub-bands and downlink sub-bands and as a result, uplink sub-bands and downlink sub-bands for UE SBFD communications may be smaller (e.g., in frequency span and/or range) than uplink sub-bands and downlink sub-bands for network node SBFD communications to accommodate the larger guard band size.

In some aspects, the first set of frequency resources includes the first subset of frequency resources for downlink full-duplex communications and the second subset of frequency resources for uplink full-duplex communications. In such aspects, determining the second set of frequency resources may include deriving the second set of frequency resources from the first set of frequency resources by applying a first guard band extension value to the first subset of frequency resources to obtain the second guard band size and decrease a size of each frequency resource of the first subset of frequency resources and/or by applying a second guard band extension value that is different from the first guard band extension value, to the second subset of frequency resources to obtain the second guard band size. For example, a different guard band size extension may be applied to each sub-band and as a result, each frequency resource for UE SBFD communications may be smaller (e.g., in frequency span and/or range) than sub-bands for network node SBFD communications to accommodate the larger guard band size. Some frequency resources for UE SBFD communications may be a different size and/or may be decreased differently than other frequency resources for UE SBFD communications.

In some aspects, the UE 120 may determine the second set of frequency resources by deriving the second set of frequency resources from the first set of frequency resources. For example, the UE 120 may increase the first guard band size to obtain the second guard band size using (e.g., applying, decreasing and/or increasing) by one or more guard band extension values (e.g., described in connection with reference number 625).

In some aspects, the UE 120 may determine the second set of frequency resources by deriving the second set of frequency resources from the first set of frequency resources. For example, the UE 120 may decrease a frequency range of each frequency resource by a respective value to obtain the second guard band size.

In some aspects, the UE 120 may determine the second set of frequency resources by deriving the second set of frequency resources from the first set of frequency resources. For example, the UE 120 may apply the second guard band size to one or more guard bands that are adjacent to at least one frequency resource of the first set of frequency resources, where the second guard band size is greater than the first guard band size. For example, the UE 120 may apply a dedicated guard-band to the SBFD-aware slots to obtain the frequency resources for UE SBFD slots. In some aspects, the UE 120 may receive an indication of the second guard band and/or the second guard band size in association with the guard band indication described in connection with reference number 625, and or the resource indication described in connection with reference number 630.

As shown by reference number 640, the network node 110 may transmit, and the UE 120 may receive, a cell-specific frequency resource configuration. For example, the network node 110 may transmit, and the UE 120 may receive a cell-specific SBFD configuration including a third set of frequency resources, wherein the second set of frequency resources is UE-specific and overrides the cell-specific SBFD configuration. In some aspects, a frequency indication container associated with the second set of frequency resources may include a cell-specific configuration and if a UE-specific configuration exists, the UE-specific configuration may override (e.g., take priority, be implemented instead of) the cell-specific configuration. In such aspects, the UE-specific configuration may be associated with an advanced UE capability and thus prioritizing the UE-specific configuration may enable the use of narrower guard bands without negatively affecting UEs without such capabilities.

As shown by reference number 645, in some aspects, the UE 120 may perform half-duplex communications with the network node 110. For example, the UE 120 may perform half-duplex communications during the third set of one or more time resources (e.g., indicated by the SBFD time resource configuration described in connection with reference number 615) that includes at least one time resource of the first set of one or more time resources (e.g., the network node SBFD time resources and/or slots). In some aspects, the network node 110 may perform SBFD communications during one or more time resources of the third set of one or more time resources and/or may perform half-duplex communications during one or more time resources of the third set of one or more time resources.

As shown by reference number 650, the network node 110 and/or the UE 120 may perform full-duplex communications. For example, the UE 120 may perform full-duplex (e.g., SBFD) communications via the second set of frequency resources and/or the network node 110 may perform full-duplex (e.g., SBFD) communications via the first set of frequency resources.

As indicated above, FIG. 6 is provided as an example. Other examples may differ from what is described with respect to FIG. 6.

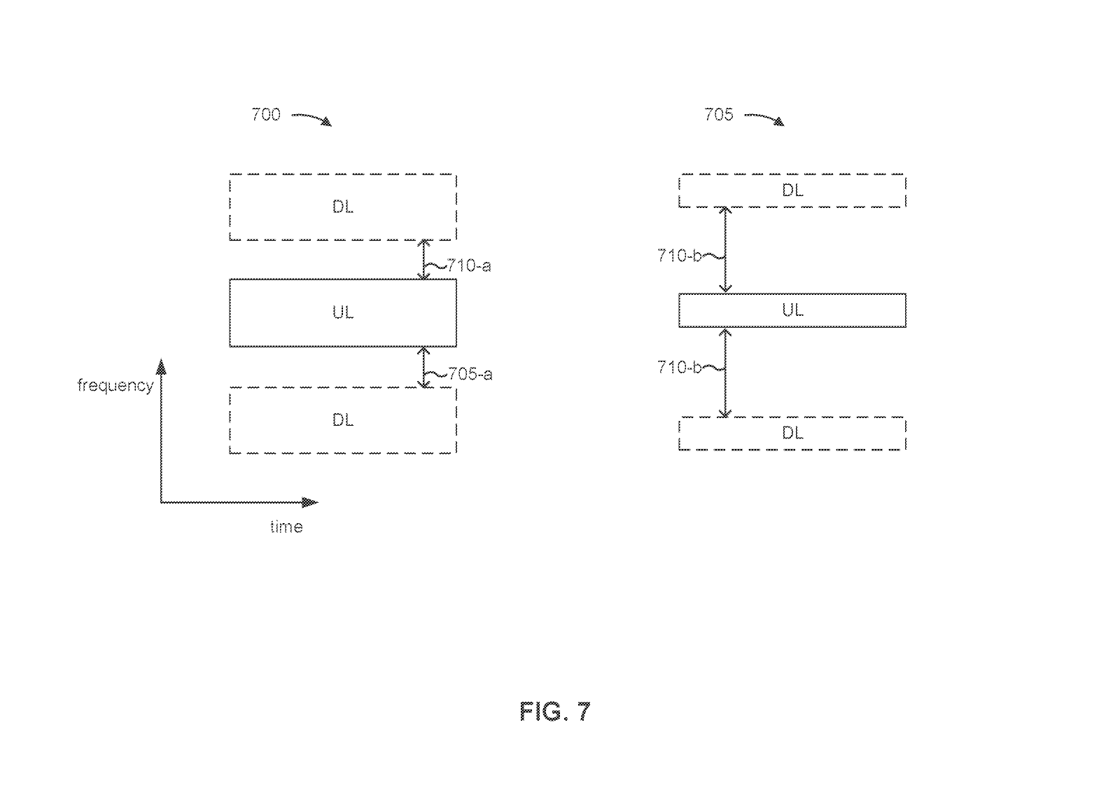

FIG. 7 is a diagram illustrating examples 700 and 705 associated with frequency resources for SBFD communications, in accordance with the present disclosure. Example 700 depicts a frequency resource configuration for network node SBFD communications and example 705 depicts a frequency resource configuration for UE SBFD communications. The frequency resource configuration for network node SBFD communications may be associated with a guard band size 710-a. The frequency resource configuration for network node SBFD communications may be associated with a guard band size 710-b. The frequency resource configurations depicted in examples 700 and/or 705 may be specific to a single time resource (e.g., slot) and/or may apply to a plurality of time resources.

In the example, 700, a network node may perform SBFD communications via the uplink and downlink frequency resources according to the guard band 710-a. In such examples, a UE may perform SBFD-aware communications. For example, the UE may perform half-duplex communications via the uplink and downlink frequency resources.

In the example, 705, a UE may perform SBFD communications via the uplink and downlink frequency resources according to the guard band 710-b. In such examples, a network node may perform SBFD communications with the UE via the uplink and downlink frequency resources according to the guard band 710-b, may perform SBFD communications with another UE (e.g., an SBFD-aware UE) via uplink and downlink frequency resources according to the guard band 710-a, and/or may perform SBFD communications with another UE (e.g., an SBFD-capable UE) via the uplink and downlink frequency resources according to a different guard band 710. As a result, the network node may communicate with the UE according to the example 705 including frequency resources associated with the UE (e.g., according to SBFD capability as related to guard band size) and may perform SBFD communications with other devices according to the example 700. For example, communicating according to a frequency resource configuration of the UE may not limit the SBFD frequency configuration of a network node in other scenarios.

As indicated above, FIG. 7 is provided as an example. Other examples may differ from what is described with respect to FIG. 7.

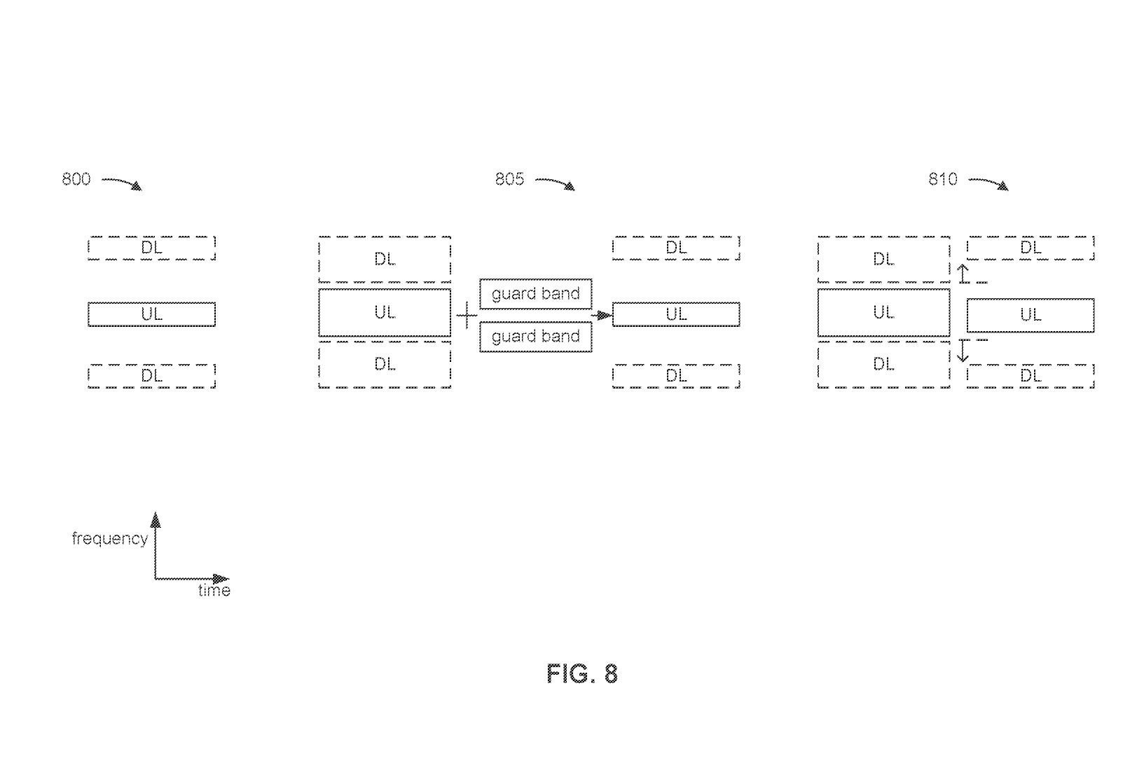

FIG. 8 is a diagram illustrating examples 800, 805, and 810 associated with determining frequency resources for UE SBFD communications, in accordance with the present disclosure.

Example 800 depicts a dedicated frequency resource configuration for UE SBFD communications. For example, a UE may receive an explicit indication of the frequency resources for UE SBFD communications. In some aspects, the indication may include an explicit frequency range for each of one or more downlink resources, and/or one or more uplink resources. In some aspects, the UE may receive the explicit indication of the frequency resources for UE SBFD communications in addition to or in conjunction with an indication of frequency resources for network node SBFD communications (e.g., including frequency resources for SBFD-aware UE communications). In some examples, a start and length indicator value may include the indication of the frequency resources for UE SBFD communications.

Example 805 depicts a dedicated guard-band to apply to the SBFD-aware resource configurations. For example, the UE may receive an explicit indication of one or more guard bands (e.g., a frequency range for each guard band) and/or one or more guard band sizes (e.g., quantity of resources between uplink and/or downlink frequency resources) for UE SBFD communications. In some aspects, the UE may receive the explicit indication of the one or more guard bands and/or one or more guard band sizes in addition to or in conjunction with an indication of frequency resources for network node SBFD communications (e.g., including frequency resources for SBFD-aware UE communications). In some examples, a start and length indicator value may include the indication of the one or more guard bands and/or one or more guard band sizes. The UE may receive the indication of frequency resources for network node SBFD communications and apply the one or more guard bands and/or one or more guard band sizes to the indicated frequency resources to determine (e.g., derive, calculate, obtain, identify) frequency resources for UE SBFD communications. In such examples, each UE SBFD frequency resource may be a subset of a network node SBFD frequency resource. As a result, the network node may communicate with the SBFD UE on narrower resources to accommodate the increased guard band size used to mitigate self-interference at the UE.

Example 810 depicts a guard band extension value that is applied to frequency resources for network node SBFD communications to determine the UE SBFD frequency resources. For example, the UE may receive an indication of one or more guard band extension values including a quantity of resources by which to reduce uplink and/or downlink frequency resources to accommodate a larger guard band size, and/or a quantity of resources by which to increase a guard band between uplink and/or downlink frequency resources to accommodate a larger guard band size for UE SBFD communications. In some examples, the guard band extension value includes a quantity of resource elements, a quantity of resource blocks, a quantity of resource block groups, and/or a quantity and/or range of MHz. In some aspects, the indication may include a specific sub-band to which each extension value may be applied. For example, the extension value may be applied to downlink frequency resources to increase the guard band size, as shown by example 810. In some aspects, the extension value may be applied to uplink frequency resources to increase the guard band size. In some aspects, the extension value may be applied to uplink frequency resources and downlink frequency resources to increase the guard band size. In some aspects, the extension value may be applied to a subset of frequency resources, independent of link type, to increase the guard band size. In some aspects, the extension value may be different for each frequency resource and/or for each link type.

In some aspects, usable physical resource blocks (e.g., time/frequency resources eligible for UE SBFD communications) in each of the examples 800, 805, and/or 810 may include a subset of physical resource blocks allocated for SBFD-aware communications. For example, physical resource blocks that are not allocated for SBFD-aware communications may not be allocated for UE SBFD communications. In some aspects, the downlink and/or uplink physical resource blocks of SBFD-aware slots usable for UE SBFD communications may include downlink and/or uplink physical resource blocks that overlap with the downlink sub-band(s) of the SBFD-aware frequency resources. Additionally or alternatively, the downlink and/or uplink physical resource blocks of SBFD-aware slots usable for UE SBFD communications may not include physical resource blocks that at least partially overlap with one or more guard bands of the SBFD-aware frequency resources.

As indicated above, FIG. 8 is provided as an example. Other examples may differ from what is described with respect to FIG. 8.

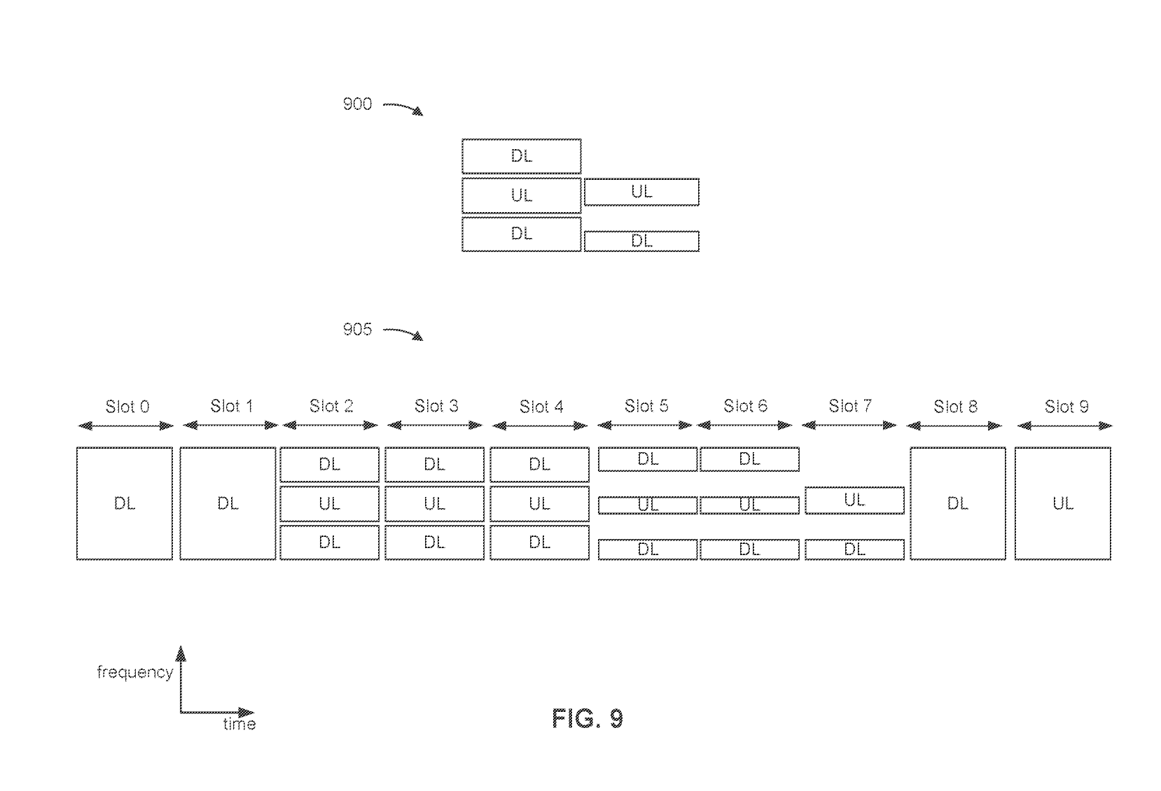

FIG. 9 is a diagram illustrating examples 900 and 905 associated with frequency resources for UE SBFD communications, in accordance with the present disclosure.

The example 900 illustrates a UE SBFD frequency configuration including a smaller quantity of resources than a SBFD-aware frequency resource configuration (e.g., network node-only SBFD frequency resource configuration). For example, SBFD-aware slots may include three frequency resources and/or sub-bands, and the SBFD-UE slots may include two frequency resources and/or sub-bands. In such aspects, the network node may perform SBFD communications with another device via the extra downlink frequency resource. In some aspects, a UE may determine the UE SBFD frequency resources based on an indication of frequency resources (e.g., described in connection with example 800 of FIG. 8) that indicates frequency ranges for a quantity of sub-bands (e.g., such as two in the example 900). In some other aspects, a UE may determine the UE SBFD frequency resources based on an indication of the guard band and/or guard band size (e.g., described in connection with example 805 of FIG. 8). In such aspects, at least one of the indicated guard bands and or guard band sizes may span a frequency range of at least one frequency resource of the network node SBFD frequency resources. In some other aspects, a UE may determine the UE SBFD frequency resources based on an indication of one or more guard band extension values (e.g., described in connection with example 810 of FIG. 8). In such aspects, at least one extension value may span a frequency range of at least one frequency resource of the network node SBFD frequency resources. In some other aspects, a UE may determine the UE SBFD frequency resources based on an explicit indication of which sub-bands are not included in the UE SBFD frequency resources and/or which sub-bands are not included in the UE SBFD frequency resources. For example, in the example 900, a bit-map of [011] may indicate that the UE SBFD frequency resources may not include a first downlink resource of the network node SBFD frequency resources and/or may include a first uplink resource and a second downlink resource of the network node SBFD frequency resources.

The example 905 illustrates a combined SBFD-aware frequency configuration and UE SBFD frequency configuration. The example 905 may include ten slots of which a subset may be for SBFD-aware communications (e.g., network node-only SBFD communications, UE half-duplex communications via the network node SBFD frequency resources) (e.g., slot 2, slot 3, and slot 4), a subset may be for UE SBFD communications (e.g., slot 5, slot 6, slot 7), and a subset may be for half-duplex communications for the network node and the UE (e.g., slot 0, slot 1, slot 8, and slot 9). In some aspects, SBFD-aware slots may be associated with a same frequency domain allocation. For example, each of slot 2, slot 3, and slot 4 may be associated with a same set of frequency resources for SBFD-aware communications. However, different frequency domain allocations for UE SBFD slots may be enabled by cell-specific UE SBFD frequency configurations and UE-specific UE SBFD frequency configurations. For example, slot 5, and slot 6 may have a same frequency allocation which may be different than a frequency allocation for slot 7. In some other examples, frequency domain allocations for UE SBFD slots may be the same for all UE SBFD time resources.

In some aspects, a UE SBFD frequency configuration (e.g., frequency indication container) may be cell-specific. In some aspects, a UE SBFD frequency configuration (e.g., frequency indication container) may be cell-specific but different for each UE with a cell and common for all bandwidth parts. In some aspects, a UE SBFD frequency configuration (e.g., frequency indication container) may be bandwidth part-specific. In some aspects, a UE SBFD frequency configuration (e.g., frequency indication container) may be cell-specific and may be overridden by a UE-specific UE SBFD frequency configuration. As a result, a minimum UE capability may be accounted for while providing flexibility for UEs with advanced capabilities.

For example, a UE may be associated with different capabilities such as a baseline guard band between downlink and uplink frequency resources that is supported by the UE when the SBFD frequency resource configuration includes a first quantity of frequency resources. A UE may be associated with different capabilities such as a baseline guard band between downlink and uplink frequency resources that is supported by the UE when the SBFD frequency resource configuration includes a second quantity of frequency resources. In some aspects, some UEs may support different baseline guard bands than other UEs. In some aspects, a UE may be associated with different capabilities based on a frequency band and/or a sub-carrier spacing. For example, a baseline guard band associated with the first quantity of frequency resources and/or the second quantity of frequency resources may be different for each frequency band and/or sub-carrier spacing supporting UE communications.

As indicated above, FIG. 9 is provided as an example. Other examples may differ from what is described with respect to FIG. 9.

FIG. 10 is a diagram illustrating an example process 1000 performed, for example, at a UE or an apparatus of a UE, in accordance with the present disclosure. Example process 1000 is an example where the apparatus or the UE (e.g., UE 120) performs operations associated with frequency domain resources for full-duplex UE.

As shown in FIG. 10, in some aspects, process 1000 may include receiving, from a network node, an SBFD frequency resource configuration indicating a first set of frequency resources for network node full-duplex communications, wherein the SBFD frequency resource configuration indicates a first guard band size of the first set of frequency resources (block 1010). For example, the UE (e.g., using reception component 1202 and/or communication manager 1206, depicted in FIG. 12) may receive, from a network node, an SBFD frequency resource configuration indicating a first set of frequency resources for network node full-duplex communications, wherein the SBFD frequency resource configuration indicates a first guard band size of the first set of frequency resources, as described above in connection with reference number 620 of FIG. 6.

As further shown in FIG. 10, in some aspects, process 1000 may include determining a second set of frequency resources for UE full-duplex communications in accordance with the SBFD frequency resource configuration, wherein the second set of frequency resources corresponds to a second guard band size (block 1020). For example, the UE (e.g., using communication manager 1206, depicted in FIG. 12) may determine a second set of frequency resources for UE full-duplex communications in accordance with the SBFD frequency resource configuration, wherein the second set of frequency resources corresponds to a second guard band size, as described above in connection with reference number 635 of FIG. 6.

As further shown in FIG. 10, in some aspects, process 1000 may include performing full-duplex communications via the second set of frequency resources (block 1030). For example, the UE (e.g., using communication manager 1206, depicted in FIG. 12) may perform full-duplex communications via the second set of frequency resources, as described above in connection with reference number 650 of FIG. 6.

Process 1000 may include additional aspects, such as any single aspect or any combination of aspects described below and/or in connection with one or more other processes described elsewhere herein.

In a first aspect, the first set of frequency resources includes a first subset of frequency resources for downlink full-duplex communications and a second subset of frequency resources for uplink full-duplex communications.

In a second aspect, alone or in combination with the first aspect, determining the second set of frequency resources comprises deriving the second set of frequency resources from the first set of frequency resources by applying a guard band extension value to the first guard band size to obtain the second guard band size and decrease a frequency range of each frequency resource of the first subset of frequency resources.

In a third aspect, alone or in combination with one or more of the first and second aspects, determining the second set of frequency resources comprises deriving the second set of frequency resources from the first set of frequency resources by applying a guard band extension value to the first guard band size to obtain the second guard band size and decrease a frequency range of each frequency resource of the second subset of frequency resources.

In a fourth aspect, alone or in combination with one or more of the first through third aspects, determining the second set of frequency resources comprises deriving the second set of frequency resources from the first set of frequency resources by applying a guard band extension value to the first guard band size to obtain the second guard band size and decrease a frequency range of each frequency resource of the first subset of frequency resources and the second subset of frequency resources.

In a fifth aspect, alone or in combination with one or more of the first through fourth aspects, determining the second set of frequency resources comprises deriving the second set of frequency resources from the first set of frequency resources by applying a first guard band extension value to the first subset of frequency resources to obtain the second guard band size and decrease a size of each frequency resource of the first subset of frequency resources, and applying a second guard band extension value that is different from the first guard band extension value, to the second subset of frequency resources to obtain the second guard band size.

In a sixth aspect, alone or in combination with one or more of the first through fifth aspects, determining the second set of frequency resources comprises deriving the second set of frequency resources from the first set of frequency resources by increasing the first guard band size to obtain the second guard band size using one or more guard band extension values.

In a seventh aspect, alone or in combination with one or more of the first through sixth aspects, the one or more guard band extension values include at least one of a quantity of resource elements, a quantity of resource blocks, a quantity of resource block groups, or a quantity of megahertz.

In an eighth aspect, alone or in combination with one or more of the first through seventh aspects, process 1000 includes receiving at least one of an indication of the one or more guard band extension values, or an indication of which guard band extension values of the one or more extension values correspond to which frequency resources of the first set of frequency resources.

In a ninth aspect, alone or in combination with one or more of the first through eighth aspects, determining the second set of frequency resources comprises deriving the second set of frequency resources from the first set of frequency resources by decreasing a frequency range of each frequency resource by a respective value to obtain the second guard band size.

In a tenth aspect, alone or in combination with one or more of the first through ninth aspects, determining the second set of frequency resources comprises receiving, from the network node, at least one of an indication of the second set of frequency resources or a guard band extension value.

In an eleventh aspect, alone or in combination with one or more of the first through tenth aspects, the indication of the second set of resources includes a quantity of frequency resources.

In a twelfth aspect, alone or in combination with one or more of the first through eleventh aspects, the indication of the second set of frequency resources indicates a quantity of frequency resources that is less than a quantity of frequency resources of the first set of frequency resources.

In a thirteenth aspect, alone or in combination with one or more of the first through twelfth aspects, the indication of the second set of resources includes a set of one or more guard bands associated with the second guard band size.

In a fourteenth aspect, alone or in combination with one or more of the first through thirteenth aspects, the indication of the second set of frequency resources includes a set of one or more guard bands associated with the second guard band size, and wherein at least one guard band of the set of one or more guard bands overlaps with at least one resource of the first set of frequency resources.

In a fifteenth aspect, alone or in combination with one or more of the first through fourteenth aspects, the guard band extension value is greater than or equal to a frequency range of at least one resource of the first set of frequency resources.

In a sixteenth aspect, alone or in combination with one or more of the first through fifteenth aspects, the indication of the second set of frequency resources includes a bit map indicating that the second set of frequency resources includes a subset of the first set of frequency resources.

In a seventeenth aspect, alone or in combination with one or more of the first through sixteenth aspects, process 1000 includes receiving, from the network node, an SBFD time resource configuration indicating a first set of one or more time resources that is for the network node full-duplex communications, and a second set of one or more time resources that is for the UE full-duplex communications.

In an eighteenth aspect, alone or in combination with one or more of the first through seventeenth aspects, each resource of the second set of one or more time resources is associated with a same set of frequency resources.

In a nineteenth aspect, alone or in combination with one or more of the first through eighteenth aspects, a first resource of the second set of one or more time resources is associated with a different set of frequency resources than a second resource of the second set of one or more time resources.

In a twentieth aspect, alone or in combination with one or more of the first through nineteenth aspects, process 1000 includes performing half-duplex communications during a third set of one or more time resources that includes at least one time resource of the first set of one or more time resources.

In a twenty-first aspect, alone or in combination with one or more of the first through twentieth aspects, the second set of one or more time resources is a subset of the first set of one or more time resources.

In a twenty-second aspect, alone or in combination with one or more of the first through twenty-first aspects, the first set of one or more time resources at least partially overlaps with the second set of one or more time resources.

In a twenty-third aspect, alone or in combination with one or more of the first through twenty-second aspects, the first set of one or more time resources and the second set of one or more time resources are disjoint sets.

In a twenty-fourth aspect, alone or in combination with one or more of the first through twenty-third aspects, a set of usable physical resource blocks associated with the SBFD time resource configuration excludes one or more physical resource blocks that at least partially overlap with at least one guard band associated with the first set of frequency resources or the second set of frequency resources, or both.

In a twenty-fifth aspect, alone or in combination with one or more of the first through twenty-fourth aspects, a set of usable physical resource blocks associated with the SBFD time resource configuration includes one or more physical resource blocks that at least partially overlap with at least one resource of at least one of the first set of frequency resources or the second set of frequency resources, or both.

In a twenty-sixth aspect, alone or in combination with one or more of the first through twenty-fifth aspects, determining the second set of frequency resources comprises deriving the second set of frequency resources from the first set of frequency resources by applying the second guard band size to one or more guard bands that are adjacent to at least one frequency resource of the first set of frequency resources, wherein the second guard band size is greater than the first guard band size.

In a twenty-seventh aspect, alone or in combination with one or more of the first through twenty-sixth aspects, process 1000 includes receiving an indication of the second guard band size.

In a twenty-eighth aspect, alone or in combination with one or more of the first through twenty-seventh aspects, process 1000 includes receiving a start and length indicator value including at least one of the first set of frequency resources or the second set of frequency resources.

In a twenty-ninth aspect, alone or in combination with one or more of the first through twenty-eighth aspects, the second set of frequency resources includes a quantity of frequency resources for uplink UE full-duplex communications and a quantity of frequency resources for downlink UE full-duplex communications.

In a thirtieth aspect, alone or in combination with one or more of the first through twenty-ninth aspects, the second set of frequency resources for performing UE full-duplex communications is the same for each UE in a cell associated with the UE.

In a thirty-first aspect, alone or in combination with one or more of the first through thirtieth aspects, the second set of frequency resources is specific to UE full-duplex communications associated with a cell and is different for each UE associated with the cell.

In a thirty-second aspect, alone or in combination with one or more of the first through thirty-first aspects, the second set of frequency resources is specific to UE full-duplex communications associated with a bandwidth part.

In a thirty-third aspect, alone or in combination with one or more of the first through thirty-second aspects, process 1000 includes receiving, from the network node, a cell-specific SBFD configuration including a third set of frequency resources, wherein the second set of frequency resources is UE-specific and overrides the cell-specific SBFD configuration.

In a thirty-fourth aspect, alone or in combination with one or more of the first through thirty-third aspects, process 1000 includes transmitting an SBFD capability message indicating at least one capability of the UE.

In a thirty-fifth aspect, alone or in combination with one or more of the first through thirty-fourth aspects, the SBFD capability message indicates at least one of a first baseline guard band corresponding to a first quantity of frequency resources, or a second baseline guard band, different from the first baseline guard band, corresponding to a second quantity of frequency resources.

In a thirty-sixth aspect, alone or in combination with one or more of the first through thirty-fifth aspects, the at least one capability of the UE corresponds to one or more of a subcarrier spacing associated with communications at the UE, or a frequency range associated with communications at the UE.

Although FIG. 10 shows example blocks of process 1000, in some aspects, process 1000 may include additional blocks, fewer blocks, different blocks, or differently arranged blocks than those depicted in FIG. 10. Additionally, or alternatively, two or more of the blocks of process 1000 may be performed in parallel.

FIG. 11 is a diagram illustrating an example process 1100 performed, for example, at a network node or an apparatus of a network node, in accordance with the present disclosure. Example process 1100 is an example where the apparatus or the network node (e.g., network node 110) performs operations associated with frequency domain resources for full-duplex UE.

As shown in FIG. 11, in some aspects, process 1100 may include transmitting, to a UE, a first SBFD frequency resource configuration indicating a first set of frequency resources that are for network node full-duplex communications, wherein the SBFD frequency resource configuration indicates a first guard band size of the first set of frequency resources (block 1110). For example, the network node (e.g., using transmission component 1304 and/or communication manager 1306, depicted in FIG. 13) may transmit, to a UE, a first SBFD frequency resource configuration indicating a first set of frequency resources that are for network node full-duplex communications, wherein the SBFD frequency resource configuration indicates a first guard band size of the first set of frequency resources, as described above in connection with reference number 620 of FIG. 6.

As further shown in FIG. 11, in some aspects, process 1100 may include transmitting, to the UE, an indication associated with a second set of frequency resources that are for UE full-duplex communications, wherein the second set of frequency resources corresponds to a second guard band size (block 1120). For example, the network node (e.g., using transmission component 1304 and/or communication manager 1306, depicted in FIG. 13) may transmit, to the UE, an indication associated with a second set of frequency resources that are for UE full-duplex communications, wherein the second set of frequency resources corresponds to a second guard band size, as described above in connection with reference number 620 and/or 630 of FIG. 6.

As further shown in FIG. 11, in some aspects, process 1100 may include performing full-duplex communications via the first set of frequency resources (block 1130). For example, the network node (e.g., using communication manager 1306, depicted in FIG. 13) may perform full-duplex communications via the first set of frequency resources, as described above in connection with reference number 650 of FIG. 6.

Process 1100 may include additional aspects, such as any single aspect or any combination of aspects described below and/or in connection with one or more other processes described elsewhere herein.

In a first aspect, the first set of frequency resources includes a first subset of frequency resources for downlink full-duplex communications and a second subset of frequency resources for uplink full-duplex communications.

In a second aspect, alone or in combination with the first aspect, the indication includes one or more guard band extension values for deriving the second set of frequency resources from the first set of frequency resources and that increases a guard band size between adjacent frequency resources of the first set of frequency resources.

In a third aspect, alone or in combination with one or more of the first and second aspects, the one or more guard band extension values include at least one of a quantity of resource elements, a quantity of resource blocks, a quantity of resource block groups, or a quantity of megahertz.

In a fourth aspect, alone or in combination with one or more of the first through third aspects, process 1100 includes receiving at least one of an indication of the one or more guard band extension values, or an indication of which guard band extension values of the one or more extension values correspond to which frequency resources of the first set of frequency resources.

In a fifth aspect, alone or in combination with one or more of the first through fourth aspects, determining the second set of frequency resources comprises deriving the second set of frequency resources from the first set of frequency resources by decreasing a frequency range of each frequency resource by a respective value to obtain the second guard band size.

In a sixth aspect, alone or in combination with one or more of the first through fifth aspects, the indication associated with the second set of frequency resources includes at least one of an indication of the second set of frequency resources or a guard band extension value.

In a seventh aspect, alone or in combination with one or more of the first through sixth aspects, the indication of the second set of resources includes a quantity of frequency resources.

In an eighth aspect, alone or in combination with one or more of the first through seventh aspects, the indication of the second set of frequency resources indicates a quantity of frequency resources that is less than a quantity of frequency resources of the first set of frequency resources.

In a ninth aspect, alone or in combination with one or more of the first through eighth aspects, the indication of the second set of resources includes a set of one or more guard bands associated with the second guard band size.

In a tenth aspect, alone or in combination with one or more of the first through ninth aspects, the indication of the second set of frequency resources includes a set of one or more guard bands associated with the second guard band size, and wherein at least one guard band of the set of one or more guard bands overlaps with at least one resource of the first set of frequency resources.

In an eleventh aspect, alone or in combination with one or more of the first through tenth aspects, the guard band extension value is greater than or equal to a frequency range of at least one resource of the first set of frequency resources.

In a twelfth aspect, alone or in combination with one or more of the first through eleventh aspects, the indication of the second set of frequency resources includes a bit map indicating that the second set of frequency resources includes a subset of the first set of frequency resources.

In a thirteenth aspect, alone or in combination with one or more of the first through twelfth aspects, process 1100 includes transmitting an SBFD time resource configuration indicating a first set of one or more time resources that is for the network node full-duplex communications, and a second set of one or more time resources that is for the UE full-duplex communications.

In a fourteenth aspect, alone or in combination with one or more of the first through thirteenth aspects, each resource of the second set of one or more time resources is associated with a same set of frequency resources.

In a fifteenth aspect, alone or in combination with one or more of the first through fourteenth aspects, a first resource of the second set of one or more time resources is associated with a different set of frequency resources than a second resource of the second set of one or more time resources.

In a sixteenth aspect, alone or in combination with one or more of the first through fifteenth aspects, process 1100 includes performing half-duplex communications during a third set of one or more time resources that includes at least one time resource of the first set of one or more time resources.

In a seventeenth aspect, alone or in combination with one or more of the first through sixteenth aspects, the second set of one or more time resources is a subset of the first set of one or more time resources.

In an eighteenth aspect, alone or in combination with one or more of the first through seventeenth aspects, the first set of one or more time resources at least partially overlaps with the second set of one or more time resources.

In a nineteenth aspect, alone or in combination with one or more of the first through eighteenth aspects, the first set of one or more time resources and the second set of one or more time resources are disjoint sets.

In a twentieth aspect, alone or in combination with one or more of the first through nineteenth aspects, a set of usable physical resource blocks associated with the SBFD time resource configuration excludes one or more physical resource blocks that at least partially overlap with at least one guard band associated with the first set of frequency resources or the second set of frequency resources, or both.

In a twenty-first aspect, alone or in combination with one or more of the first through twentieth aspects, a set of usable physical resource blocks associated with the SBFD time resource configuration includes one or more physical resource blocks that at least partially overlap with at least one resource of at least one of the first set of frequency resources or the second set of frequency resources, or both.

In a twenty-second aspect, alone or in combination with one or more of the first through twenty-first aspects, the indication includes the second guard band size.

In a twenty-third aspect, alone or in combination with one or more of the first through twenty-second aspects, process 1100 includes transmitting a start and length indicator value including at least one of the first set of frequency resources or the second set of frequency resources.

In a twenty-fourth aspect, alone or in combination with one or more of the first through twenty-third aspects, the second set of frequency resources includes a quantity of frequency resources for uplink UE full-duplex communications and a quantity of frequency resources for downlink UE full-duplex communications.

In a twenty-fifth aspect, alone or in combination with one or more of the first through twenty-fourth aspects, the second set of frequency resources for performing UE full-duplex communications is the same for each UE in a cell associated with the UE.

In a twenty-sixth aspect, alone or in combination with one or more of the first through twenty-fifth aspects, the second set of frequency resources is specific to UE full-duplex communications associated with a cell and is different for each UE associated with the cell.

In a twenty-seventh aspect, alone or in combination with one or more of the first through twenty-sixth aspects, the second set of frequency resources is specific to UE full-duplex communications associated with a bandwidth part.

In a twenty-eighth aspect, alone or in combination with one or more of the first through twenty-seventh aspects, process 1100 includes transmitting, to the UE, a cell-specific SBFD configuration including a third set of frequency resources, wherein the second set of frequency resources is UE-specific and overrides the cell-specific SBFD configuration.

In a twenty-ninth aspect, alone or in combination with one or more of the first through twenty-eighth aspects, process 1100 includes receiving an SBFD capability message indicating at least one capability of the UE.

In a thirtieth aspect, alone or in combination with one or more of the first through twenty-ninth aspects, the SBFD capability message indicates at least one of a first baseline guard band corresponding to a first quantity of frequency resources, or a second baseline guard band, different from the first baseline guard band, corresponding to a second quantity of frequency resources.

In a thirty-first aspect, alone or in combination with one or more of the first through thirtieth aspects, the at least one capability of the UE corresponds to one or more of a subcarrier spacing associated with communications at the UE, or a frequency range associated with communications at the UE.

Although FIG. 11 shows example blocks of process 1100, in some aspects, process 1100 may include additional blocks, fewer blocks, different blocks, or differently arranged blocks than those depicted in FIG. 11. Additionally, or alternatively, two or more of the blocks of process 1100 may be performed in parallel.

FIG. 12 is a diagram of an example apparatus 1200 for wireless communication, in accordance with the present disclosure. The apparatus 1200 may be a UE, or a UE may include the apparatus 1200. In some aspects, the apparatus 1200 includes a reception component 1202, a transmission component 1204, and/or a communication manager 1206, which may be in communication with one another (for example, via one or more buses and/or one or more other components). In some aspects, the communication manager 1206 is the communication manager 150 described in connection with FIG. 1. As shown, the apparatus 1200 may communicate with another apparatus 1208, such as a UE or a network node (such as a CU, a DU, an RU, or a base station), using the reception component 1202 and the transmission component 1204. The communication manager 1206 may be included in, or implemented via, a processing system (for example, the processing system 140 described in connection with FIG. 1) of the UE.

In some aspects, the apparatus 1200 may be configured to perform one or more operations described herein in connection with FIGS. 6-9 Additionally, or alternatively, the apparatus 1200 may be configured to perform one or more processes described herein, such as process 1000 of FIG. 10, or a combination thereof. In some aspects, the apparatus 1200 and/or one or more components shown in FIG. 12 may include one or more components of the UE described in connection with FIG. 1. Additionally, or alternatively, one or more components shown in FIG. 12 may be implemented within one or more components described in connection with FIG. 1. Additionally, or alternatively, one or more components of the set of components may be implemented at least in part as software stored in one or more memories. For example, a component (or a portion of a component) may be implemented as instructions or code stored in a non-transitory computer-readable medium and executable by one or more controllers or one or more processors to perform the functions or operations of the component.

The reception component 1202 may receive communications, such as reference signals, control information, data communications, or a combination thereof, from the apparatus 1208. The reception component 1202 may provide received communications to one or more other components of the apparatus 1200. In some aspects, the reception component 1202 may perform signal processing on the received communications, and may provide the processed signals to the one or more other components of the apparatus 1200. In some aspects, the reception component 1202 may include one or more components of the UE described above in connection with FIG. 1, such as a radio, one or more RF chains, one or more transceivers, or one or more modems, each of which may in turn be coupled with one or more antennas of the UE.

The transmission component 1204 may transmit communications, such as reference signals, control information, data communications, or a combination thereof, to the apparatus 1208. In some aspects, one or more other components of the apparatus 1200 may generate communications and may provide the generated communications to the transmission component 1204 for transmission to the apparatus 1208. In some aspects, the transmission component 1204 may perform signal processing on the generated communications, and may transmit the processed signals to the apparatus 1208. In some aspects, the transmission component 1204 may include one or more components of the UE described above in connection with FIG. 1, such as a radio, one or more RF chains, one or more transceivers, or one or more modems, each of which may in turn be coupled with one or more antennas of the UE described in connection with FIG. 1. In some aspects, the transmission component 1204 may be co-located with the reception component 1202.

The communication manager 1206 may support operations of the reception component 1202 and/or the transmission component 1204. For example, the communication manager 1206 may receive information associated with configuring reception of communications by the reception component 1202 and/or transmission of communications by the transmission component 1204. Additionally, or alternatively, the communication manager 1206 may generate and/or provide control information to the reception component 1202 and/or the transmission component 1204 to control reception and/or transmission of communications.

The reception component 1202 may receive, from a network node, an SBFD frequency resource configuration indicating a first set of frequency resources for network node full-duplex communications, wherein the SBFD frequency resource configuration indicates a first guard band size of the first set of frequency resources. The communication manager 1206 may determine a second set of frequency resources for UE full-duplex communications in accordance with the SBFD frequency resource configuration, wherein the second set of frequency resources corresponds to a second guard band size. The communication manager 1206 may perform full-duplex communications via the second set of frequency resources.

The reception component 1202 may receive at least one of an indication of the one or more guard band extension values, or an indication of which guard band extension values of the one or more extension values correspond to which frequency resources of the first set of frequency resources.

The reception component 1202 may receive, from the network node, an SBFD time resource configuration indicating a first set of one or more time resources that is for the network node full-duplex communications, and a second set of one or more time resources that is for the UE full-duplex communications.

The communication manager 1206 may perform half-duplex communications during a third set of one or more time resources that includes at least one time resource of the first set of one or more time resources.

The reception component 1202 may receive an indication of the second guard band size.

The reception component 1202 may receive a start and length indicator value including at least one of the first set of frequency resources or the second set of frequency resources.

The reception component 1202 may receive, from the network node, a cell-specific SBFD configuration including a third set of frequency resources, wherein the second set of frequency resources is UE-specific and overrides the cell-specific SBFD configuration.

The transmission component 1204 may transmit an SBFD capability message indicating at least one capability of the UE.

The number and arrangement of components shown in FIG. 12 are provided as an example. In practice, there may be additional components, fewer components, different components, or differently arranged components than those shown in FIG. 12. Furthermore, two or more components shown in FIG. 12 may be implemented within a single component, or a single component shown in FIG. 12 may be implemented as multiple, distributed components. Additionally, or alternatively, a set of (one or more) components shown in FIG. 12 may perform one or more functions described as being performed by another set of components shown in FIG. 12.

FIG. 13 is a diagram of an example apparatus 1300 for wireless communication, in accordance with the present disclosure. The apparatus 1300 may be a network node, or a network node may include the apparatus 1300. In some aspects, the apparatus 1300 includes a reception component 1302, a transmission component 1304, and/or a communication manager 1306, which may be in communication with one another (for example, via one or more buses and/or one or more other components). In some aspects, the communication manager 1306 is the communication manager 155 described in connection with FIG. 1. As shown, the apparatus 1300 may communicate with another apparatus 1308, such as a UE or a network node (such as a CU, a DU, an RU, or a base station), using the reception component 1302 and the transmission component 1304. The communication manager 1306 may be included in, or implemented via, a processing system (for example, the processing system 145 described in connection with FIG. 1) of the network node.

In some aspects, the apparatus 1300 may be configured to perform one or more operations described herein in connection with FIGS. 6-9 Additionally, or alternatively, the apparatus 1300 may be configured to perform one or more processes described herein, such as process 1100 of FIG. 11, or a combination thereof. In some aspects, the apparatus 1300 and/or one or more components shown in FIG. 13 may include one or more components of the network node described in connection with FIG. 1. Additionally, or alternatively, one or more components shown in FIG. 13 may be implemented within one or more components described in connection with FIG. 1. Additionally, or alternatively, one or more components of the set of components may be implemented at least in part as software stored in one or more memories. For example, a component (or a portion of a component) may be implemented as instructions or code stored in a non-transitory computer-readable medium and executable by one or more controllers or one or more processors to perform the functions or operations of the component.

The reception component 1302 may receive communications, such as reference signals, control information, data communications, or a combination thereof, from the apparatus 1308. The reception component 1302 may provide received communications to one or more other components of the apparatus 1300. In some aspects, the reception component 1302 may perform signal processing on the received communications, and may provide the processed signals to the one or more other components of the apparatus 1300. In some aspects, the reception component 1302 may include one or more components of the network node described above in connection with FIG. 1, such as a radio, one or more RF chains, one or more transceivers, or one or more modems, each of which may in turn be coupled with one or more antennas of the network node. In some aspects, the reception component 1302 and/or the transmission component 1304 may include or may be included in a network interface. The network interface may be configured to obtain and/or output signals for the apparatus 1300 via one or more communications links, such as a backhaul link, a midhaul link, and/or a fronthaul link.

The transmission component 1304 may transmit communications, such as reference signals, control information, data communications, or a combination thereof, to the apparatus 1308. In some aspects, one or more other components of the apparatus 1300 may generate communications and may provide the generated communications to the transmission component 1304 for transmission to the apparatus 1308. In some aspects, the transmission component 1304 may perform signal processing on the generated communications, and may transmit the processed signals to the apparatus 1308. In some aspects, the transmission component 1304 may include one or more components of the network node described above in connection with FIG. 1, such as a radio, one or more RF chains, one or more transceivers, or one or more modems, each of which may in turn be coupled with one or more antennas of the network node described in connection with FIG. 1. In some aspects, the transmission component 1304 may be co-located with the reception component 1302.

The communication manager 1306 may support operations of the reception component 1302 and/or the transmission component 1304. For example, the communication manager 1306 may receive information associated with configuring reception of communications by the reception component 1302 and/or transmission of communications by the transmission component 1304. Additionally, or alternatively, the communication manager 1306 may generate and/or provide control information to the reception component 1302 and/or the transmission component 1304 to control reception and/or transmission of communications.

The transmission component 1304 may transmit, to a UE, a first SBFD frequency resource configuration indicating a first set of frequency resources that are for network node full-duplex communications, wherein the SBFD frequency resource configuration indicates a first guard band size of the first set of frequency resources. The transmission component 1304 may transmit, to the UE, an indication associated with a second set of frequency resources that are for UE full-duplex communications, wherein the second set of frequency resources corresponds to a second guard band size. The communication manager 1306 may perform full-duplex communications via the first set of frequency resources.

The reception component 1302 may receive at least one of an indication of the one or more guard band extension values, or an indication of which guard band extension values of the one or more extension values correspond to which frequency resources of the first set of frequency resources.

The transmission component 1304 may transmit an SBFD time resource configuration indicating a first set of one or more time resources that is for the network node full-duplex communications, and a second set of one or more time resources that is for the UE full-duplex communications.

The communication manager 1306 may perform half-duplex communications during a third set of one or more time resources that includes at least one time resource of the first set of one or more time resources.

The transmission component 1304 may transmit a start and length indicator value including at least one of the first set of frequency resources or the second set of frequency resources.

The transmission component 1304 may transmit, to the UE, a cell-specific SBFD configuration including a third set of frequency resources, wherein the second set of frequency resources is UE-specific and overrides the cell-specific SBFD configuration.

The reception component 1302 may receive an SBFD capability message indicating at least one capability of the UE.

The number and arrangement of components shown in FIG. 13 are provided as an example. In practice, there may be additional components, fewer components, different components, or differently arranged components than those shown in FIG. 13. Furthermore, two or more components shown in FIG. 13 may be implemented within a single component, or a single component shown in FIG. 13 may be implemented as multiple, distributed components. Additionally, or alternatively, a set of (one or more) components shown in FIG. 13 may perform one or more functions described as being performed by another set of components shown in FIG. 13.

The following provides an overview of some Aspects of the present disclosure:

Aspect 1: A method of wireless communication performed by a user equipment (UE), comprising: receiving, from a network node, a sub-band full-duplex (SBFD) frequency resource configuration indicating a first set of frequency resources for network node full-duplex communications, wherein the SBFD frequency resource configuration indicates a first guard band size of the first set of frequency resources; determining a second set of frequency resources for UE full-duplex communications in accordance with the SBFD frequency resource configuration, wherein the second set of frequency resources corresponds to a second guard band size; and performing full-duplex communications via the second set of frequency resources.

Aspect 2: The method of Aspect 1, wherein the first set of frequency resources includes a first subset of frequency resources for downlink full-duplex communications and a second subset of frequency resources for uplink full-duplex communications.

Aspect 3: The method of Aspect 2, wherein determining the second set of frequency resources comprises: deriving the second set of frequency resources from the first set of frequency resources by applying a guard band extension value to the first guard band size to obtain the second guard band size and decrease a frequency range of each frequency resource of the first subset of frequency resources.

Aspect 4: The method of Aspect 2, wherein determining the second set of frequency resources comprises: deriving the second set of frequency resources from the first set of frequency resources by applying a guard band extension value to the first guard band size to obtain the second guard band size and decrease a frequency range of each frequency resource of the second subset of frequency resources.

Aspect 5: The method of Aspect 2, wherein determining the second set of frequency resources comprises: deriving the second set of frequency resources from the first set of frequency resources by applying a guard band extension value to the first guard band size to obtain the second guard band size and decrease a frequency range of each frequency resource of the first subset of frequency resources and the second subset of frequency resources.

Aspect 6: The method of Aspect 2, wherein determining the second set of frequency resources comprises: deriving the second set of frequency resources from the first set of frequency resources by: applying a first guard band extension value to the first subset of frequency resources to obtain the second guard band size and decrease a size of each frequency resource of the first subset of frequency resources; and applying a second guard band extension value that is different from the first guard band extension value, to the second subset of frequency resources to obtain the second guard band size.

Aspect 7: The method of any of Aspects 1-6, wherein determining the second set of frequency resources comprises: deriving the second set of frequency resources from the first set of frequency resources by increasing the first guard band size to obtain the second guard band size using one or more guard band extension values.

Aspect 8: The method of Aspect 7, wherein the one or more guard band extension values include at least one of: a quantity of resource elements, a quantity of resource blocks, a quantity of resource block groups, or a quantity of megahertz.

Aspect 9: The method of any of Aspects 7-8, further comprising: receiving at least one of: an indication of the one or more guard band extension values, or an indication of which guard band extension values of the one or more extension values correspond to which frequency resources of the first set of frequency resources.

Aspect 10: The method of any of Aspects 1-9, wherein determining the second set of frequency resources comprises: deriving the second set of frequency resources from the first set of frequency resources by decreasing a frequency range of each frequency resource by a respective value to obtain the second guard band size.

Aspect 11: The method of any of Aspects 1-10, wherein determining the second set of frequency resources comprises: receiving, from the network node, at least one of an indication of the second set of frequency resources or a guard band extension value.

Aspect 12: The method of Aspect 11, wherein the indication of the second set of resources includes a quantity of frequency resources.

Aspect 13: The method of any of Aspects 11-12, wherein the indication of the second set of frequency resources indicates a quantity of frequency resources that is less than a quantity of frequency resources of the first set of frequency resources.

Aspect 14: The method of any of Aspects 11-13, wherein the indication of the second set of resources includes a set of one or more guard bands associated with the second guard band size.

Aspect 15: The method of any of Aspects 11-14, wherein the indication of the second set of frequency resources includes a set of one or more guard bands associated with the second guard band size, and wherein at least one guard band of the set of one or more guard bands overlaps with at least one resource of the first set of frequency resources.

Aspect 16: The method of any of Aspects 11-14, wherein the guard band extension value is greater than or equal to a frequency range of at least one resource of the first set of frequency resources.

Aspect 17: The method of any of Aspects 11-14, wherein the indication of the second set of frequency resources includes a bit map indicating that the second set of frequency resources includes a subset of the first set of frequency resources.

Aspect 18: The method of any of Aspects 1-17, further comprising: receiving, from the network node, an SBFD time resource configuration indicating a first set of one or more time resources that is for the network node full-duplex communications, and a second set of one or more time resources that is for the UE full-duplex communications.

Aspect 19: The method of Aspect 18, wherein each resource of the second set of one or more time resources is associated with a same set of frequency resources.

Aspect 20: The method of Aspect 18, wherein a first resource of the second set of one or more time resources is associated with a different set of frequency resources than a second resource of the second set of one or more time resources.

Aspect 21: The method of any of Aspects 18-20, further comprising: performing half-duplex communications during a third set of one or more time resources that includes at least one time resource of the first set of one or more time resources.

Aspect 22: The method of any of Aspects 18-21, wherein the second set of one or more time resources is a subset of the first set of one or more time resources.

Aspect 23: The method of any of Aspects 18-21, wherein the first set of one or more time resources at least partially overlaps with the second set of one or more time resources.

Aspect 24: The method of any of Aspects 18-21, wherein the first set of one or more time resources and the second set of one or more time resources are disjoint sets.

Aspect 25: The method of any of Aspects 18-24, wherein a set of usable physical resource blocks associated with the SBFD time resource configuration excludes one or more physical resource blocks that at least partially overlap with at least one guard band associated with the first set of frequency resources or the second set of frequency resources, or both.

Aspect 26: The method of of any of Aspects 18-24, wherein a set of usable physical resource blocks associated with the SBFD time resource configuration includes one or more physical resource blocks that at least partially overlap with at least one resource of at least one of the first set of frequency resources or the second set of frequency resources, or both.

Aspect 27: The method of any of Aspects 1-26, wherein determining the second set of frequency resources comprises: deriving the second set of frequency resources from the first set of frequency resources by applying the second guard band size to one or more guard bands that are adjacent to at least one frequency resource of the first set of frequency resources, wherein the second guard band size is greater than the first guard band size.

Aspect 28: The method of Aspect 27, further comprising: receiving an indication of the second guard band size.

Aspect 29: The method of any of Aspects 1-28, further comprising: receiving a start and length indicator value including at least one of the first set of frequency resources or the second set of frequency resources.

Aspect 30: The method of any of Aspects 1-29, wherein the second set of frequency resources includes a quantity of frequency resources for uplink UE full-duplex communications and a quantity of frequency resources for downlink UE full-duplex communications.

Aspect 31: The method of any of Aspects 1-30, wherein the second set of frequency resources for performing UE full-duplex communications is the same for each UE in a cell associated with the UE.

Aspect 32: The method of any of Aspects 1-31, wherein the second set of frequency resources is specific to UE full-duplex communications associated with a cell and is different for each UE associated with the cell.

Aspect 33: The method of any of Aspects 1-32, wherein the second set of frequency resources is specific to UE full-duplex communications associated with a bandwidth part.

Aspect 34: The method of any of Aspects 1-33, further comprising: receiving, from the network node, a cell-specific SBFD configuration including a third set of frequency resources, wherein the second set of frequency resources is UE-specific and overrides the cell-specific SBFD configuration.

Aspect 35: The method of any of Aspects 1-34, further comprising: transmitting an SBFD capability message indicating at least one capability of the UE.

Aspect 36: The method of Aspect 35, wherein the SBFD capability message indicates at least one of: a first baseline guard band corresponding to a first quantity of frequency resources, or a second baseline guard band, different from the first baseline guard band, corresponding to a second quantity of frequency resources.

Aspect 37: The method of any of Aspects 35-36, wherein the at least one capability of the UE corresponds to one or more of: a subcarrier spacing associated with communications at the UE, or a frequency range associated with communications at the UE.

Aspect 38: A method of wireless communication performed by a network node, comprising: transmitting, to a user equipment (UE), a first sub-band full-duplex (SBFD) frequency resource configuration indicating a first set of frequency resources that are for network node full-duplex communications, wherein the SBFD frequency resource configuration indicates a first guard band size of the first set of frequency resources; transmitting, to the UE, an indication associated with a second set of frequency resources that are for UE full-duplex communications, wherein the second set of frequency resources corresponds to a second guard band size; and performing full-duplex communications via the first set of frequency resources.

Aspect 39: The method of Aspect 38, wherein the first set of frequency resources includes a first subset of frequency resources for downlink full-duplex communications and a second subset of frequency resources for uplink full-duplex communications.

Aspect 40: The method of any of Aspects 38-39, wherein the indication includes one or more guard band extension values for deriving the second set of frequency resources from the first set of frequency resources and that increases a guard band size between adjacent frequency resources of the first set of frequency resources.

Aspect 41: The method of Aspect 40, wherein the one or more guard band extension values include at least one of: a quantity of resource elements, a quantity of resource blocks, a quantity of resource block groups, or a quantity of megahertz.

Aspect 42: The method of Aspect 40, further comprising: receiving at least one of: an indication of the one or more guard band extension values, or an indication of which guard band extension values of the one or more extension values correspond to which frequency resources of the first set of frequency resources.

Aspect 43: The method of any of Aspects 38-42, wherein determining the second set of frequency resources comprises: deriving the second set of frequency resources from the first set of frequency resources by decreasing a frequency range of each frequency resource by a respective value to obtain the second guard band size.

Aspect 44: The method of Aspect 38, wherein the indication associated with the second set of frequency resources includes at least one of an indication of the second set of frequency resources or a guard band extension value.

Aspect 45: The method of Aspect 44, wherein the indication of the second set of resources includes a quantity of frequency resources.

Aspect 46: The method of any of Aspects 44-45, wherein the indication of the second set of frequency resources indicates a quantity of frequency resources that is less than a quantity of frequency resources of the first set of frequency resources.

Aspect 47: The method of any of Aspects 44-46, wherein the indication of the second set of resources includes a set of one or more guard bands associated with the second guard band size.

Aspect 48: The method of any of Aspects 44-47, wherein the indication of the second set of frequency resources includes a set of one or more guard bands associated with the second guard band size, and wherein at least one guard band of the set of one or more guard bands overlaps with at least one resource of the first set of frequency resources.

Aspect 49: The method of any of Aspects 44-48, wherein the guard band extension value is greater than or equal to a frequency range of at least one resource of the first set of frequency resources.

Aspect 50: The method of any of Aspects 44-49, wherein the indication of the second set of frequency resources includes a bit map indicating that the second set of frequency resources includes a subset of the first set of frequency resources.

Aspect 51: The method of any of Aspects 38-50, further comprising: transmitting an SBFD time resource configuration indicating a first set of one or more time resources that is for the network node full-duplex communications, and a second set of one or more time resources that is for the UE full-duplex communications.

Aspect 52: The method of Aspect 51, wherein each resource of the second set of one or more time resources is associated with a same set of frequency resources.

Aspect 53: The method of Aspect 51, wherein a first resource of the second set of one or more time resources is associated with a different set of frequency resources than a second resource of the second set of one or more time resources.

Aspect 54: The method of any of Aspects 51-53, further comprising: performing half-duplex communications during a third set of one or more time resources that includes at least one time resource of the first set of one or more time resources.

Aspect 55: The method of any of Aspects 51-54, wherein the second set of one or more time resources is a subset of the first set of one or more time resources.

Aspect 56: The method of any of Aspects 51-54, wherein the first set of one or more time resources at least partially overlaps with the second set of one or more time resources.

Aspect 57: The method of any of Aspects 51-54, wherein the first set of one or more time resources and the second set of one or more time resources are disjoint sets.

Aspect 58: The method of any of Aspects 51-57, wherein a set of usable physical resource blocks associated with the SBFD time resource configuration excludes one or more physical resource blocks that at least partially overlap with at least one guard band associated with the first set of frequency resources or the second set of frequency resources, or both.

Aspect 59: The method of any of Aspects 51-57, wherein a set of usable physical resource blocks associated with the SBFD time resource configuration includes one or more physical resource blocks that at least partially overlap with at least one resource of at least one of the first set of frequency resources or the second set of frequency resources, or both.

Aspect 60: The method of any of Aspects 38-59, wherein the indication includes the second guard band size.

Aspect 61: The method of any of Aspects 38-60, further comprising: transmitting a start and length indicator value including at least one of the first set of frequency resources or the second set of frequency resources.

Aspect 62: The method of any of Aspects 38-61, wherein the second set of frequency resources includes a quantity of frequency resources for uplink UE full-duplex communications and a quantity of frequency resources for downlink UE full-duplex communications.

Aspect 63: The method of any of Aspects 38-62, wherein the second set of frequency resources for performing UE full-duplex communications is the same for each UE in a cell associated with the UE.

Aspect 64: The method of any of Aspects 38-63, wherein the second set of frequency resources is specific to UE full-duplex communications associated with a cell and is different for each UE associated with the cell.

Aspect 65: The method of any of Aspects 38-64, wherein the second set of frequency resources is specific to UE full-duplex communications associated with a bandwidth part.

Aspect 66: The method of any of Aspects 38-65, further comprising: transmitting, to the UE, a cell-specific SBFD configuration including a third set of frequency resources, wherein the second set of frequency resources is UE-specific and overrides the cell-specific SBFD configuration.

Aspect 67: The method of any of Aspects 38-66, further comprising: receiving an SBFD capability message indicating at least one capability of the UE.

Aspect 68: The method of Aspect 67, wherein the SBFD capability message indicates at least one of: a first baseline guard band corresponding to a first quantity of frequency resources, or a second baseline guard band, different from the first baseline guard band, corresponding to a second quantity of frequency resources.

Aspect 69: The method of any of Aspects 67-68, wherein the at least one capability of the UE corresponds to one or more of: a subcarrier spacing associated with communications at the UE, or a frequency range associated with communications at the UE.

Aspect 70: An apparatus for wireless communication at a device, the apparatus comprising one or more processors; one or more memories coupled with the one or more processors; and instructions stored in the one or more memories and executable by the one or more processors to cause the apparatus to perform the method of one or more of Aspects 1-69.

Aspect 71: An apparatus for wireless communication at a device, the apparatus comprising one or more memories and one or more processors coupled to the one or more memories, the one or more processors configured to cause the device to perform the method of one or more of Aspects 1-69.

Aspect 72: An apparatus for wireless communication, the apparatus comprising at least one means for performing the method of one or more of Aspects 1-69.

Aspect 73: A non-transitory computer-readable medium storing code for wireless communication, the code comprising instructions executable by one or more processors to perform the method of one or more of Aspects 1-69.

Aspect 74: A non-transitory computer-readable medium storing a set of instructions for wireless communication, the set of instructions comprising one or more instructions that, when executed by one or more processors of a device, cause the device to perform the method of one or more of Aspects 1-69.

Aspect 75: A device for wireless communication, the device comprising a processing system that includes one or more processors and one or more memories coupled with the one or more processors, the processing system configured to cause the device to perform the method of one or more of Aspects 1-69.

Aspect 76: An apparatus for wireless communication at a device, the apparatus comprising one or more memories and one or more processors coupled to the one or more memories, the one or more processors individually or collectively configured to cause the device to perform the method of one or more of Aspects 1-69.

The foregoing disclosure provides illustration and description but is not intended to be exhaustive or to limit the aspects to the precise forms disclosed. Modifications and variations may be made in light of the above disclosure or may be acquired from practice of the aspects. No element, act, or instruction described herein should be construed as critical or essential unless explicitly described as such.

It will be apparent that systems or methods described herein may be implemented in different forms of hardware or a combination of hardware and software. The actual specialized control hardware or software used to implement these systems or methods is not limiting of the aspects. Thus, the operation and behavior of the systems or methods are described herein without reference to specific software code, because those skilled in the art will understand that software and hardware can be designed to implement the systems or methods based, at least in part, on the description herein. A component being configured to perform a function means that the component has a capability to perform the function, and does not require the function to be actually performed by the component, unless noted otherwise.

As used herein, the articles “a” and “an” are intended to refer to one or more items and may be used interchangeably with “one or more” or “at least one.” Further, as used herein, the article “the” is intended to include one or more items referenced in connection with the article “the” and may be used interchangeably with “the one or more.” Furthermore, as used herein, the terms “set” and “group” are intended to include one or more items and may be used interchangeably with “one or more.” Where only one item is intended, the phrase “only one” or “a single one” or similar language is used. Also, as used herein, the terms “has,” “have,” “having,” “comprise,” “comprising,” “include” and “including,” and derivatives thereof or similar terms are intended to be open-ended terms that do not limit an element that they modify (for example, an element “having” A may also have B). Also, as used herein, the term “or” is intended to be inclusive when used in a series and may be used interchangeably with “and/or,” unless explicitly stated otherwise (for example, if used in combination with “either” or “only one of”). As used herein, a phrase referring to “at least one of” a list of items refers to any combination of those items, including single members. As an example, “at least one of: a, b, or c” is intended to cover a, b, c, a + b, a + c, b + c, and a + b + c, as well as any combination with multiples of the same element (for example, a + a, a + a + a, a + a + b, a + a + c, a + b + b, a + c + c, b + b, b + b + b, b + b + c, c + c, and c + c + c, or any other ordering of a, b, and c).

As used herein, the term “determine” or “determining” encompasses a wide variety of actions and, therefore, “determining” can include calculating, computing, processing, deriving, estimating, investigating, looking up (such as via looking up in a table, a database, or another data structure), searching, inferring, ascertaining, and/or measuring, among other possibilities. Also, “determining” can include receiving (such as receiving information), accessing (such as accessing data stored in memory) or transmitting (such as transmitting information), among other possibilities. Additionally, “determining” can include resolving, selecting, obtaining, choosing, establishing, and/or other such similar actions.

As used herein, the phrase “based on” is intended to mean “based at least in part on” or “based on or otherwise in association with” unless explicitly stated otherwise. As used herein, “satisfying a threshold” may, depending on the context, refer to a value being greater than the threshold, greater than or equal to the threshold, less than the threshold, less than or equal to the threshold, equal to the threshold, or not equal to the threshold, among other examples.

Even though particular combinations of features are recited in the claims or disclosed in the specification, these combinations are not intended to limit the scope of all aspects described herein. Many of these features may be combined in ways not specifically recited in the claims or disclosed in the specification. The disclosure of various aspects includes each dependent claim in combination with every other claim in the claim set.

What is claimed is:

1. An apparatus for wireless communication at a user equipment (UE), comprising:
one or more memories; and
one or more processors, coupled to the one or more memories, configured to cause the UE to:
receive, from a network node, a sub-band full-duplex (SBFD) frequency resource configuration indicating a first set of frequency resources for network node full-duplex communications, wherein the SBFD frequency resource configuration indicates a first guard band size of the first set of frequency resources;
determine a second set of frequency resources for UE full-duplex communications in accordance with the SBFD frequency resource configuration, wherein the second set of frequency resources corresponds to a second guard band size; and
perform full-duplex communications via the second set of frequency resources.

2. The apparatus of claim 1, wherein the first set of frequency resources includes a first subset of frequency resources for downlink full-duplex communications and a second subset of frequency resources for uplink full-duplex communications.

3. The apparatus of claim 2, wherein the one or more processors, to cause the UE to determine the second set of frequency resources, are configured to cause the UE to:
derive the second set of frequency resources from the first set of frequency resources by applying a guard band extension value to the first guard band size to obtain the second guard band size and decrease a frequency range of each frequency resource of the first subset of frequency resources.

4. The apparatus of claim 2, wherein the one or more processors, to cause the UE to determine the second set of frequency resources, are configured to cause the UE to:
derive the second set of frequency resources from the first set of frequency resources by applying a guard band extension value to the first guard band size to obtain the second guard band size and decrease a frequency range of each frequency resource of the second subset of frequency resources.

5. The apparatus of claim 2, wherein the one or more processors, to cause the UE to determine the second set of frequency resources, are configured to cause the UE to:
derive the second set of frequency resources from the first set of frequency resources by applying a guard band extension value to the first guard band size to obtain the second guard band size and decrease a frequency range of each frequency resource of the first subset of frequency resources and the second subset of frequency resources.

6. The apparatus of claim 2, wherein the one or more processors, to cause the UE to determine the second set of frequency resources, are configured to cause the UE to:
derive the second set of frequency resources from the first set of frequency resources by causing the UE to:
apply a first guard band extension value to the first subset of frequency resources to obtain the second guard band size and decrease a size of each frequency resource of the first subset of frequency resources; and
apply a second guard band extension value that is different from the first guard band extension value, to the second subset of frequency resources to obtain the second guard band size.

7. A method of wireless communication performed by a user equipment (UE), comprising:
receiving, from a network node, a sub-band full-duplex (SBFD) frequency resource configuration indicating a first set of frequency resources for network node full-duplex communications, wherein the SBFD frequency resource configuration indicates a first guard band size of the first set of frequency resources;
determining a second set of frequency resources for UE full-duplex communications in accordance with the SBFD frequency resource configuration, wherein the second set of frequency resources corresponds to a second guard band size; and
performing full-duplex communications via the second set of frequency resources.

8. The method of claim 7, wherein determining the second set of frequency resources comprises:
deriving the second set of frequency resources from the first set of frequency resources by increasing the first guard band size to obtain the second guard band size using one or more guard band extension values.

9. The method of claim 7, wherein determining the second set of frequency resources comprises:
deriving the second set of frequency resources from the first set of frequency resources by decreasing a frequency range of each frequency resource by a respective value to obtain the second guard band size.

10. The method of claim 7, wherein determining the second set of frequency resources comprises:
receiving, from the network node, at least one of an indication of the second set of frequency resources or a guard band extension value.

11. The method of claim 7, further comprising:
receiving, from the network node, an SBFD time resource configuration indicating a first set of one or more time resources that is for the network node full-duplex communications, and a second set of one or more time resources that is for the UE full-duplex communications.

12. The method of claim 7, wherein determining the second set of frequency resources comprises:
deriving the second set of frequency resources from the first set of frequency resources by applying the second guard band size to one or more guard bands that are adjacent to at least one frequency resource of the first set of frequency resources, wherein the second guard band size is greater than the first guard band size.

13. The method of claim 7, wherein the second set of frequency resources includes a quantity of frequency resources for uplink UE full-duplex communications and a quantity of frequency resources for downlink UE full-duplex communications.

14. A non-transitory computer-readable medium storing a set of instructions for wireless communication, the set of instructions comprising:
one or more instructions that, when executed by one or more processors of a user equipment (UE), cause the UE to:
receive, from a network node, a sub-band full-duplex (SBFD) frequency resource configuration indicating a first set of frequency resources for network node full-duplex communications, wherein the SBFD frequency resource configuration indicates a first guard band size of the first set of frequency resources;
determine a second set of frequency resources for UE full-duplex communications in accordance with the SBFD frequency resource configuration, wherein the second set of frequency resources corresponds to a second guard band size; and
perform full-duplex communications via the second set of frequency resources.

15. The non-transitory computer-readable medium of claim 14, wherein the second set of frequency resources for performing UE full-duplex communications is the same for each UE in a cell associated with the UE.

16. The non-transitory computer-readable medium of claim 14, wherein the second set of frequency resources is specific to UE full-duplex communications associated with a cell and is different for each UE associated with the cell.

17. The non-transitory computer-readable medium of claim 14, wherein the second set of frequency resources is specific to UE full-duplex communications associated with a bandwidth part.

18. The non-transitory computer-readable medium of claim 14, wherein the one or more instructions further cause the UE to:
receive, from the network node, a cell-specific SBFD configuration including a third set of frequency resources, wherein the second set of frequency resources is UE-specific and overrides the cell-specific SBFD configuration.

19. The non-transitory computer-readable medium of claim 14, wherein the one or more instructions further cause the UE to:
transmit an SBFD capability message indicating at least one capability of the UE.

20. The non-transitory computer-readable medium of claim 19, wherein the SBFD capability message indicates at least one of:
a first baseline guard band corresponding to a first quantity of frequency resources, or
a second baseline guard band, different from the first baseline guard band, corresponding to a second quantity of frequency resources.
